(19) United States
(12) Patent Application Publication
(10) Pub. No.: US 2024/0181708 A1
(43) Pub. Date: Jun. 6, 2024

(54) MANUFACTURING METHOD OF THREE-DIMENSIONAL FABRICATED OBJECT, AND MANUFACTURING DEVICE OF THREE-DIMENSIONAL FABRICATED OBJECT

(71) Applicant: Konica Minolta, Inc., Tokyo (JP)

(72) Inventor: Takashi Washizu, Hachioji-shi, Tokyo (JP)

(73) Assignee: Konica Minolta, Inc., Tokyo (JP)

(21) Appl. No.: 18/283,287

(22) PCT Filed: Feb. 28, 2022
(86) PCT No.: PCT/JP2022/008205

§ 371 Date: Sep. 21, 2023

(30) Foreign Application Priority Data
Mar. 31, 2021 (JP) 2021-059159

(51) Int. Cl. B29C 64/386; B29C 64/153; B29K 77/00; B29K 105/16; B29K 507/04; B33Y 30/00; B33Y 50/00

(52) U.S. Cl. CPC B29C 64/386; B33Y 30/00; B33Y 50/00; B29C 64/153; B29K 2077/00; B29K 2105/162; B29K 2507/04; B29K 2995/0005

(57) ABSTRACT

A manufacturing method of a three-dimensional fabricated object using an additive manufacturing technology, the method including: detecting, in situ, data on a physical or chemical characteristic of a three-dimensional object under fabrication.

### BACKGROUND

### Technical Field

The present invention relates to a method for manufacturing a three-dimensional fabricated object and a device for manufacturing the three-dimensional fabricated object.

More specifically, the present invention relates to a method and device for manufacturing a three-dimensional fabricated object capable of improving manufacturing efficiency or manufacturing a high-quality three-dimensional fabricated object.

### Description of Related Art

In recent years, contribution to a persistent society has been required. In such a situation, the manufacturing technology is required to change from a conventional mass production type to an on-demand type corresponding to production of a wide variety of products and a small quantity, in which a necessary product is manufactured at a necessary place when necessary. An additive manufacturing (AM) technology is expected as the on-demand type fabrication method.

The additive manufacturing technology is suitable for on-demand type manufacturing. On the other hand, in the additive manufacturing technology, there are actual situations such as lower manufacturing efficiency than injection molding, limitation on the kinds of materials that can be used, high cost, low strength of the fabricated object, and low shaping accuracy. Due to the situations, the application area of the additive manufacturing technology is limited, and the technology has not been sufficiently expanded to the manufacturing industry.

Manufacturing of a three-dimensional fabricated object using the additive manufacturing technology is performed by a series of processes including setting of manufacturing conditions (a fabrication model, a material, a structure, and fabrication conditions), fabrication based on the manufacturing conditions, and quality inspection of the fabricated object. In addition, in the stage of setting the manufacturing conditions, an operation of manufacturing a prototype and adjusting the manufacturing conditions based on the result of the quality inspection is generally repeated. Therefore, it is not rare that the series of processes is performed many times in order to manufacture a product having desired quality.

In order to expand the additive manufacturing technology to the manufacturing industry, it is necessary to construct a fabrication platform that consistently controls each process in order to take advantage of the fact that the additive manufacturing technology is suitable for on-demand manufacturing. On the platform, as illustrated in FIG. 1, data acquired in the fabrication process and the quality inspection process are fed back to a manufacturing condition setting process, and manufacturing conditions are optimized. It is important that the overall manufacturing efficiency, from condition setting to quality inspection, is good in order to be able to quickly provide what is sought with this fabrication platform.

In addition, in order to realize a sustainable society, conversion from petroleum-derived plastics, which are currently widely used, to biomass plastics is essential. However, many biomass plastics have low heat resistance and low flame retardancy, and thus have a trouble in product performance. In addition, particularly, cellulose-based biomass plastics have low fusion welding properties, and thus defects such as void generation and interlayer peeling are more likely to occur in the additive manufacturing technology than in other materials. Therefore, cellulose-based biomass plastics have troubles not only in terms of product performance but also in terms of manufacturing efficiency. In order to apply biomass plastics to the additive manufacturing technology, it is required to compensate for these defects. Therefore, it is necessary to improve the manufacturing efficiency and to construct the platform.

Means for improving the manufacturing efficiency is considered to include not only simply improving the fabrication speed, but also stopping the manufacturing in the middle of the manufacturing or to repair the fabricated object by additional processing in a case where it can be visually checked that the fabricated object has a defect in the middle of the manufacturing. However, a small defect or an internal state cannot be checked by visual inspection. Therefore, it is not until quality inspection after the completion of the fabrication process that the product is found to be a defective product as a result of visual inspection, and a large loss in time, effort, materials, and the like often occurs.

Another technology is disclosed in which, in a material extrusion deposition method that is one of additive manufacturing technologies, for the purpose of improving adhesiveness between layers, a temperature of an existing layer is adjusted based on a temperature of the existing layer measured in situ (Patent Literature 1). Further, in the same material extrusion deposition method, for the purpose of enhancing interlayer adhesion, a technology of adjusting the temperature of an ejection section in accordance with the temperature of an existing layer measured in situ (Patent Literature 2) is also disclosed. These technologies contribute to improvement in manufacturing efficiency in that a high-quality fabricated object can be stably manufactured. However, these technologies do not deal the issue that the presence or absence of a defect is not known until quality inspection after a fabrication process.

As described above, since the conventional additive manufacturing technology is not sufficient in manufacturing efficiency to be expanded to the manufacturing industry as an on-demand type fabrication method, further improvement in manufacturing efficiency has been required.

### PATENT LITERATURE

[Patent Literature 1] Japanese Unexamined Patent Publication No. 2020-131700
[Patent Literature 2] Japanese Unexamined Patent Publication No. 2020-131685

### SUMMARY

One or more embodiments of the present invention provide a method for manufacturing a three-dimensional fabricated (or molded or manufactured) object and a device for manufacturing a three-dimensional fabricated object that can improve manufacturing efficiency or manufacture a high-quality three-dimensional fabricated object.

The present inventors have found that it is possible to provide a method for manufacturing a three-dimensional fabricated object capable of improving manufacturing efficiency or manufacturing a high-quality three-dimensional fabricated object by detecting in situ data on a physical or chemical characteristic(s) of the three-dimensional fabricated object in the middle of fabrication, and thus have completed the present invention.

That is, one or more embodiments of the present invention provide the following means.

Aspect 1: A manufacturing method of a three-dimensional fabricated object using an additive manufacturing technology, the method including:
detecting, in situ, data on a physical or chemical characteristic of a three-dimensional object under fabrication.

Aspect 2: The manufacturing method of the three-dimensional fabricated object according to Aspect 1, wherein the detecting includes detecting the data from an upper surface of the three-dimensional object under fabrication.

Aspect 3: The manufacturing method of the three-dimensional fabricated object according to Aspect 1, wherein the detecting includes detecting the data from a side surface of the three-dimensional object under fabrication.

Aspect 4: The manufacturing method of the three-dimensional fabricated object according to Aspect 1, wherein the detecting includes detecting the data between layers of the three-dimensional object under fabrication.

Aspect 5: The manufacturing method of the three-dimensional fabricated object according to Aspect 1, wherein the detecting includes detecting, as the data, an X-ray interference image of the three-dimensional object under fabrication.

Aspect 6: The manufacturing method of the three-dimensional fabricated object according to Aspect 1, wherein the detecting includes detecting, as the data, a chromaticity of a surface of the three-dimensional object under fabrication.

Aspect 7: The manufacturing method of the three-dimensional fabricated object according to Aspect 1, wherein the detecting includes detecting, as the data, a dielectric constant of the three-dimensional object under fabrication.

Aspect 8: The manufacturing method of the three-dimensional fabricated object according to Aspect 1, wherein the detecting includes detecting, as the data, an electromagnetic wave reflection intensity or an electromagnetic wave absorption intensity of the three-dimensional object under fabrication.

Aspect 9: The manufacturing method of the three-dimensional fabricated object according to Aspect 1, wherein the detecting includes detecting, as the data, a progress of a chemical reaction of a material of the three-dimensional object under fabrication.

Aspect 10: The manufacturing method of the three-dimensional fabricated object according to Aspect 1, further comprising: executing, in situ, an additional process or a change in a fabrication condition depending on the data detected in the detecting.

Aspect 11: A manufacturing device of a three-dimensional fabricated object using an additive manufacturing technology, the manufacturing device comprising:
a detector that detects, in situ, data on a physical or chemical characteristic of a three-dimensional object under fabrication.

In accordance with some embodiments of the present invention, a method and a device for manufacturing a three-dimensional fabricated object are provided that are capable of improving manufacturing efficiency and manufacturing a high-quality three-dimensional fabricated object.

Technical advantages of one or more embodiments of the present invention are specifically as follows.

In the additive manufacturing technology, manufacturing conditions have not been established. Therefore, defects such as voids, cracks, or surface abnormalities are likely to occur in the additive manufacturing technology. Furthermore, the additive manufacturing technology has a low fabrication speed. For this reason, in the additive manufacturing technology, even when a defect occurs in the middle of fabrication, if the quality cannot be determined until a quality inspection or the like after the end of fabrication, a large amount of time is lost. In one or more embodiments of the present invention, data regarding physical or chemical characteristics are detected in situ. Therefore, in one or more embodiments of the present invention, it is possible to check, during the fabrication, not only a defect that is clearly visible but also a minute defect, a part in which an internal defect is likely to occur, the degree of the defect, and the like. Thus, according to one or more embodiments of the present invention, it is possible to appropriately determine whether to stop fabrication and to reduce loss of time and effort, thereby improving manufacturing efficiency. Furthermore, depending on the degree and type of a defect, there is a defect that is difficult to repair after completion of the fabrication but can be repaired during fabrication. When such a defect is found, according to one or more embodiments of the present invention, it is possible to improve the quality and to reduce the number of defective products by appropriately repairing the defect in the middle of manufacturing. Therefore, a high-quality three-dimensional fabricated object can be manufactured.

Such an advantage can be achieved in any material type. This advantage is particularly effective is particularly achieved for a material type such as a biomass plastic in which defects are particularly likely to occur due to low fusion-bonding properties or other factors. Therefore, the above-mentioned advantage not only makes it possible to improve the manufacturing efficiency, but also contributes to expansion of the kinds of materials.

Furthermore, the check of the presence or absence of a defect or the like in parallel with the fabrication makes it possible to reduce the number of inspection items in the quality inspection after the completion of the fabrication which has been conventionally performed. Therefore, also in this respect, one or more embodiments of the present invention make it possible to improve the manufacturing efficiency.

In addition, one or more embodiments of the present invention make it possible to improve the manufacturing efficiency not only in that a detection result can be obtained in the middle of fabrication but also in that data that cannot be detected after the completion of the fabrication can be detected. The data that cannot be detected after the completion of the fabrication is, for example, data relating to physical or chemical characteristics that changes over time during fabrication, such as temperature, data of a change in state, such as deterioration or shrinkage, caused by a change in temperature, data of a layer surface that is between layers after lamination and difficult to be detected, or the like. All kinds of data on the fabrication process and the fabricated object are useful for feeding back to a process of setting manufacturing conditions. In one or more embodiments of the present invention, since the data that cannot be detected after the completion of the fabrication can be detected as described above, more advanced feedback to the manufacturing condition setting process can be performed. Accordingly, it is possible to make the material and the fabrication condition more suitable. Thus, the quality can be stabilized by defect suppression and strength improvement. Thus, it is possible to improve manufacturing efficiency. Furthermore, since data that cannot be detected after the completion of the fabrication can be detected, a reduction in the number of times of prototype production in the stage of manufacturing condition setting can also be expected. Accordingly, the manufacturing efficiency can be improved in terms of time and labor.

### BRIEF DESCRIPTION OF DRAWINGS

FIG. 1 illustrates a process for manufacturing a three-dimensional fabricated object.

FIG. 2 is a schematic diagram of a three-dimensional fabrication apparatus of a material extrusion deposition type including an X-ray Talbot-Lau imaging device facing a side surface.

FIG. 3 is a schematic diagram of a three-dimensional fabrication apparatus of a material extrusion deposition type including a two-dimensional color luminance meter facing a side surface thereof.

FIG. 4 is a schematic diagram of a three-dimensional fabrication apparatus of a material extrusion deposition type including a two-dimensional color luminance meter above an upper surface thereof.

FIG. 5 is a schematic diagram of a three-dimensional fabrication apparatus of a material extrusion deposition type including a reflection frequency analyzer with a tag facing a side surface thereof.

FIG. 6 is a schematic diagram of a three-dimensional fabrication apparatus of a material extrusion deposition type including a reflection frequency analyzer with a tag above an upper surface thereof.

FIG. 7 is a schematic diagram of a three-dimensional fabrication apparatus of a material extrusion deposition type including a reflection frequency analyzer without a tag facing a side surface thereof.

FIG. 8 is a schematic diagram of a three-dimensional fabrication apparatus of a material extrusion deposition type including a reflection frequency analyzer without a tag above an upper surface thereof.

FIG. 9 illustrates a configuration example of a three-dimensional fabrication apparatus of a powder sintering lamination type.

FIG. 10 is a schematic diagram of a three-dimensional fabrication apparatus of a powder sintering lamination type including an X-ray Talbot-Lau imaging device above an upper surface thereof.

FIG. 11 is a schematic diagram of a three-dimensional fabrication apparatus of a powder sintering lamination type including a two-dimensional color luminance meter above an upper surface thereof.

FIG. 12 is a schematic diagram of a three-dimensional fabrication apparatus of a powder sintering lamination type including a reflection frequency analyzer with a tag above an upper surface thereof.

FIG. 13 is a schematic diagram of a three-dimensional fabrication apparatus of a powder sintering lamination type including a reflection frequency analyzer without a tag above an upper surface thereof.

FIG. 14 illustrates a configuration example of a three-dimensional fabrication apparatus of a material jetting type.

FIG. 15 is a schematic diagram of a three-dimensional fabrication apparatus of a material jetting type including an X-ray Talbot-Lau imaging device facing a side surface thereof.

FIG. 16 is a schematic diagram of a three-dimensional fabrication apparatus of a material jetting type including an X-ray Talbot-Lau imaging device above an upper surface thereof.

FIG. 17 is a schematic diagram of a three-dimensional fabrication apparatus of a material jetting type including a two-dimensional color luminance meter facing a side surface thereof.

FIG. 18 is a schematic diagram of a three-dimensional fabrication apparatus of a material jetting type including a two-dimensional color luminance meter above an upper surface thereof.

FIG. 19 is a schematic diagram of a three-dimensional fabrication apparatus of a material jetting type including a reflection frequency analyzer with a tag facing a side surface thereof.

FIG. 20 is a schematic diagram of a three-dimensional fabrication apparatus of a material jetting type including a reflection frequency analyzer with a tag above an upper surface thereof.

FIG. 21 illustrates a configuration example of a three-dimensional fabrication apparatus of a stereolithography type.

FIG. 22 is a schematic diagram of a three-dimensional fabrication apparatus of a stereolithography type including an X-ray Talbot-Lau imaging device facing a side surface thereof.

FIG. 23 is a schematic diagram of a three-dimensional fabrication apparatus of a stereolithography type including a two-dimensional color luminance meter facing a side surface thereof.

FIG. 24 is a schematic diagram of a three-dimensional fabrication apparatus of a stereolithography type including a reflection frequency analyzer with a tag facing a side surface thereof.

FIG. 25 is a schematic diagram of a state in which a defect is repaired in situ by irradiation with infrared rays from a laser light source as an additional process in the three-dimensional fabrication method by the material extrusion deposition method.

FIG. 26 is a schematic diagram showing a state in which a defect is repaired in situ by irradiation with infrared rays from a lamp as an additional process in the three-dimensional fabrication method by the material extrusion deposition method.

FIG. 27 is a schematic diagram of a state in which a defect is repaired in situ by irradiation with infrared rays from a laser light source as an additional process in the three-dimensional fabrication method by the powder sintering lamination method.

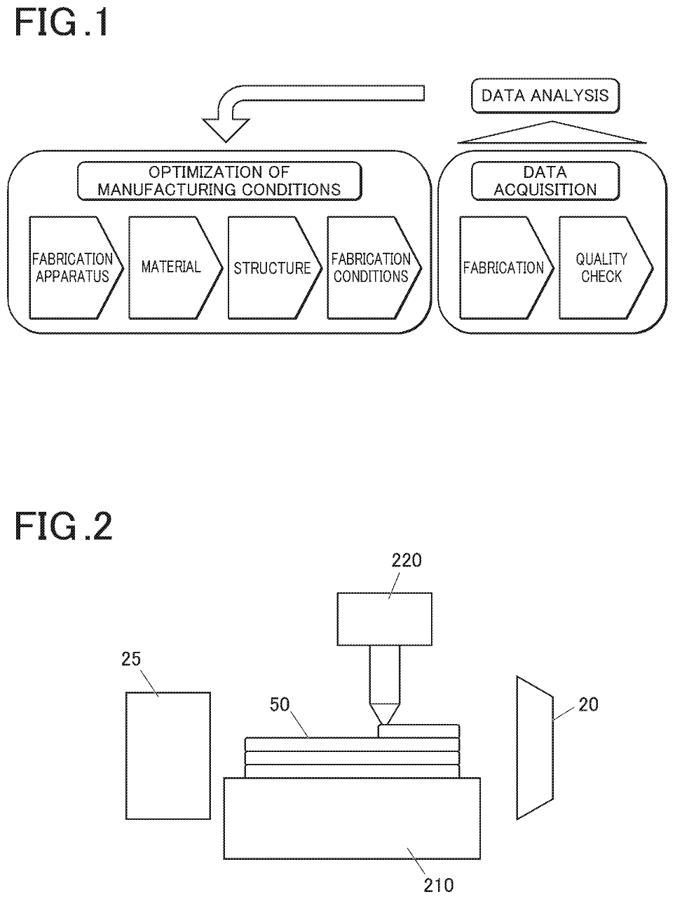

### DETAILED DESCRIPTION OF EMBODIMENTS

A method for manufacturing a three-dimensional fabricated object according to one or more embodiments of the present invention is a method for manufacturing a three-dimensional fabricated object using an additive manufacturing technology, in which data on physical or chemical characteristics of the three-dimensional fabricated object in the middle of fabrication is detected in situ.

This feature is a technical feature common to or corresponding to the following embodiments.

In the method for manufacturing a three-dimensional fabricated object according to one or more embodiments of the present invention, the data may be detected from the upper surface. The detection from the upper surface is suitable for detecting data on the surface of a layer on which the next layer is not yet laminated or data on a portion from which detection of data is difficult from the side surface.

In the method for manufacturing a three-dimensional fabricated object according to one or more embodiments of the present invention, the data may be detected from a side surface. Detection from the side surface is suitable for detecting data between layers. In addition, one or more embodiments of the present invention are also suitable for a case where it is desired to collectively detect data of each layer and between layers or a case where it is desired to perform detection by changing a time after lamination in order to check a temporal change of data.

In the method for manufacturing a three-dimensional fabricated object according to one or more embodiments of the present invention, the data between the layers of the three-dimensional fabricated object may be detected. Since defects are particularly likely to occur between the layers, useful data can be effectively obtained by detecting data between the layers.

In the method for manufacturing a three-dimensional fabricated object according to one or more embodiments of the present invention, an X-ray interference image of the three-dimensional fabricated object in the middle of fabrication may be detected as the data. Accordingly, a defect or the like inside the three-dimensional fabricated object can be detected.

In the method for manufacturing a three-dimensional fabricated object according to one or more embodiments of the present invention, the chromaticity of the surface of the three-dimensional fabricated object in the middle of fabrication may be detected as the data. Thus, an abnormality in the surface condition of the three-dimensional fabricated object or the like can be detected.

In the method for manufacturing a three-dimensional fabricated object according to one or more embodiments of the present invention, the dielectric constant of the three-dimensional fabricated object in the middle of fabrication may be detected as the data. This makes it possible to detect a step on the side surface of the three-dimensional fabricated object or a defect inside the of the three-dimensional fabricated object.

In the method for manufacturing a three-dimensional fabricated object according to one or more embodiments of the present invention, an electromagnetic wave reflection intensity or an electromagnetic wave absorption intensity of the three-dimensional fabricated object in the middle of fabrication may be detected as the data. This makes it possible to detect a step on the side surface of the three-dimensional fabricated object or a defect inside the of the three-dimensional fabricated object.

In the method for manufacturing a three-dimensional fabricated object according to one or more embodiments of the present invention, it is possible to detect, as the data, the progress of a chemical reaction of a material of the three-dimensional fabricated object in the middle of fabrication. This makes it possible to determine whether sufficient strength can be developed between the layers of the three-dimensional fabricated object.

As the method for manufacturing a three-dimensional fabricated object according to one or more embodiments of the present invention, it is possible to perform an additional process or change the fabrication conditions in situ according to the detected data. Thus, since improvement of quality and reduction of defective products can be achieved, manufacturing efficiency can be improved.

A device for manufacturing a three-dimensional fabricated object of one or more embodiments of the present invention is a device for manufacturing a three-dimensional fabricated object using an additive manufacturing technology, and includes a detector capable of detecting data related to physical or chemical characteristics of the three-dimensional fabricated object in situ.

Hereinafter, one or more embodiments of the present invention, constituent elements thereof, and modes and aspects for carrying out the present invention will be described in detail. In the present application, “to” is used as a meaning including numerical values described before and after “to” as a lower limit value and an upper limit value.

### <Outline of Method and Device for Manufacturing Three-Dimensional Fabricated Object>

A method for manufacturing a three-dimensional fabricated object according to one or more embodiments of the present invention is a method for manufacturing a three-dimensional fabricated object using an additive manufacturing technology, in which data on physical or chemical characteristics of the three-dimensional fabricated object in the middle of fabrication is detected in situ.

According to one or more embodiments of the present invention, there is provided a device for manufacturing a three-dimensional fabricated object using an additive manufacturing technology including a detector capable of detecting data on physical or chemical characteristics of the three-dimensional fabricated object in situ.

Hereinafter, the “method for manufacturing a three-dimensional fabricated object” is also referred to as a “three-dimensional fabrication method”. The “apparatus for manufacturing the three-dimensional fabricated object” is also referred to as a “three-dimensional fabrication apparatus”.

The additive manufacturing technology is a technology of obtaining a three-dimensional fabricated object by laminating and fusing or curing a material such as a resin or a metal based on three-dimensional shape data of a target three-dimensional fabricated object.

There are several methods of the additive manufacturing technology, and materials to be used, laminating methods, fusion bonding or curing methods, and the like are different from each other. The representative methods include the material extrusion deposition method (FDM: fused deposition modeling), a powder sintering lamination (SLS: selected laser sintering) method, a material jetting (MJ) method, and a stereolithography (SLA). In addition, the stereolithography is classified into a laser type and a digital light processing (DLP) type according to an ultraviolet irradiation method.

The data relating to the physical or chemical characteristics is not limited to the physical or chemical characteristics themselves of the three-dimensional fabricated object, such as temperature, X-ray interference image, chromaticity, dielectric constant, and electromagnetic wave (light) absorption intensity. Data used for detecting these (for example, reflection intensity of electromagnetic waves) and data that can be indirectly detected from these data (for example, a surface state, an internal structure, a defect, and the like) are also included in the data on the physical or chemical characteristics.

“To detect in situ” means to detect in situ without taking out the fabricated object or apart of the constituent material thereof in the middle of fabrication, instead of taking out the fabricated object or a part of the constituent material thereof in the middle of fabrication as a sample to the outside (ex situ) and detecting it. That is, “to detect in situ” means that the data in the fabricated object in the middle of fabrication is detected on site from the start of the fabrication of the first layer to the end of the fabrication of the final layer.

In the three-dimensional fabrication method of one or more embodiments of the present invention, it is possible to detect data relating to physical or chemical characteristics of each part of the three-dimensional fabricated object, particularly between layers. Defects are particularly likely to occur between layers. Therefore, by detecting data on physical or chemical characteristics between layers, useful data can be effectively obtained.

The term “between layers” refers to a space between layers that have already been laminated at the time of detection. A layer surface on which the next layer is not yet laminated at the time of detection is not “between layers”. Note that the term “between layers” is not limited to one having a physically or chemically clear interface.

In the three-dimensional fabrication method according to one or more embodiments of the present invention, the data can be detected from the upper surface or the side surface. The detection from the upper surface is suitable for detecting data of a layer surface before the next layer is laminated or data of a portion which is difficult to be detected from the side surface. Detection from the side surface is suitable for detecting data between layers. In addition, the detection from the side surface is also suitable for a case where data of each layer or between layers is desired to be collectively detected, or a case where data is desired to be detected by changing a time after lamination in order to check a change in data over time.

The “detector” according to one or more embodiments of the present invention refers to an apparatus or a device that can detect the data on the physical or chemical characteristic in situ. The details will be described in later described embodiments, but the detector includes, for example, an X-ray Talbot-Lau imaging device, a two-dimensional color luminance meter, and a reflection frequency analyzer. In addition, in contrast to the “detector”, a part of an apparatus or a device that fabricates a three-dimensional fabricated object in the three-dimensional fabrication apparatus of one or more embodiments of the present invention is referred to as a “main body section”.

Hereinafter, some embodiments will be described by taking a material extrusion deposition method (FDM), a powder sintering lamination method (SLS), a material jetting method (MJ), and a stereolithography (SLA), which are representative methods of the additive manufacturing technology, as examples.

Note that the present invention is not limited to the embodiments described below. The present invention can also be applied to other methods such as a binder jetting method (BJ) and a multijet fusion method (MJF). In addition, data regarding physical or chemical characteristics to be detected and a detection method thereof are not limited to the embodiments described below.

### Embodiment 1

In Embodiment 1, a three-dimensional fabrication method and a three-dimensional fabrication apparatus for in situ detection of data relating to physical or chemical characteristics of a three-dimensional fabricated object in the middle of fabrication in three-dimensional fabrication by a material extrusion deposition (FDM) method will be described.

### [Material Extrusion Deposition Method]

First, the material extrusion deposition method (FDM) will be described.

A three-dimensional fabrication apparatus of a material extrusion deposition type generally includes a chamber, and a raw material supplier is provided in the chamber. The raw material supplier is a heatable base, an extrusion head installed on a gantry structure, a heating and melting device, a guide for a resin composition (kneaded product), a material cartridge installation section for a hot-melt extrusion system, or the like. Some three-dimensional fabrication apparatuses have an extrusion head integrated with the heating and melting device.

Since the extrusion head is installed in a gantry structure, the extrusion head can be optionally moved in a plane direction of the base. The base is a platform on which a desired three-dimensional fabricated object, a holding material, or the like is constructed. The base may be configured to improve the adhesiveness between the respective layers when heated and incubated, or to improve the dimensional stability of the obtained three-dimensional fabricated object. Usually, at least one of the extrusion head or the base is movable in a vertical direction.

A raw material for a three-dimensional fabricated object is fed from the raw material supplier and fed to an extrusion head by a pair of rollers or gears facing each other. The raw materials are heated and melted in the extrusion head and extruded from the nozzle at the tip. For example, by a signal transmitted on the basis of a computer aided design (CAD) model, the extrusion head supplies a filament onto the base while moving and deposits the filament in layers on the base. After this step is completed, the three-dimensional fabricated object is taken out from the base. Subsequently, a desired three-dimensional fabricated object can be obtained by peeling off the holding material or the like as necessary or cutting off an excess part.

Examples of the means for continuously supplying the raw material to the extrusion head include the following.
A method of unwinding and supplying filament-fabricated resin composition
A method of supplying a powder or liquid resin composition from a tank or the like via a feeder at preset constant flow rate
A method of supplying a resin composition in the form of pellets or granules plasticized and then extruded by an extruder or the like

Hereinafter, embodiments of a three-dimensional fabrication method and a three-dimensional fabrication apparatus to which each detection method is applied in the material extrusion deposition method will be described.

### Embodiment 1-1

A three-dimensional fabrication method using a material extrusion deposition (FDM) in which an X-ray interference image of a three-dimensional fabricated object in the middle of fabrication is detected in situ by a three-dimensional fabrication apparatus including an X-ray Talbot-Lau imaging device as a detector will be described.

FIG. 2 is a schematic diagram of a three-dimensional fabrication apparatus of a material extrusion deposition type including an X-ray Talbot-Lau imaging device as a detector. Illustration of a support and the like for each component is omitted. In FIG. 2, the main body section for forming a three-dimensional fabricated object includes a fabrication table 210 serving as a base for forming a three-dimensional fabricated object, and an ejection module 220 including nozzles for ejecting a material. In the present embodiment, the X-ray source 20 is disposed facing one side surface of the main body section, and the X-ray detector 25 is disposed facing the other side surface with the three-dimensional fabricated object 50 interposed therebetween.

The X-ray source 20 includes an X-ray tube that emits X-rays and a source grating. The X-ray detector 25 includes a first grating, a second grating, and an image detector. In the source grating, the first grating, and the second grating, a plurality of slits are aligned in a direction orthogonal to an irradiation axis direction of X-rays emitted from the X-ray source. Note that a device having these three gratings is referred to as an X-ray Talbot-Lau imaging device using a Talbot-Lau interferometer. An X-ray Talbot imaging device using a Talbot interferometer that does not include the source grating and includes only the first grating and the second grating may be employed.

The X-ray Talbot-Lau imaging device including the X-ray source 20 and the X-ray detector 25 can be adjusted in position in accordance with a region of the three-dimensional fabricated object to be detected.

The detection may be performed layer by layer, or may be collectively performed after forming a plurality of layers.

The basic principle of detection using an X-ray Talbot-Lau imaging device is the same as the principle of the X-ray Talbot imaging system described in International Publication No. 2018/186296. In the X-ray Talbot-Lau imaging device, X-rays emitted from an X-ray source and transmitted through each grating and the three-dimensional fabricated object are read by an X-ray detector. Thus, a moire image that is an X-ray interference image is captured by a method based on the principle of the fringe scanning method. The X-rays are radiated so that the average energy with which the fabricated object is exposed is 15 to 30 keV. At least three types of images can be reconstructed by analyzing the moire image using a Fourier transform method or the like. The reconstructed image is referred to as a “reconstructed image”. The “reconstructed image” includes an absorption image, a differential phase image, and a small-angle scattering image. The “absorption image” is an image (the same as a normal X-ray absorption image) in which an average component of moire fringes in a moire image is imaged. The “differential phase image” is an image in which phase information of moire fringes is imaged. The “small-angle scattering image” is an image obtained by imaging the visibility of moire fringes. It is also possible to generate more types of images by, for example, resynthesizing these three types of reconstructed images.

Each of the three types of reconstructed images can be used. In the present embodiment, the differential phase image is particularly useful. The differential phase image can more clearly visualize defects such as voids and cracks inside the three-dimensional fabricated object.

The differential phase image makes it possible to check the presence or absence of a defect only by looking at the image in the case of a relatively large defect. In addition, it possible to check the presence or absence of even a minute defect by digitizing and averaging the contrast in the image.

Hereinafter, the value of the digitized and averaged contrast is referred to as a “contrast value”. By comparing the detection value of the contrast value with an optionally set reference value, it is possible to determine whether or not the defect is acceptable. According to the evaluation criterion in the determination, for example, there is no defect when the ratio [%] of the difference between the detection value of the contrast value and the reference value is less than 10%, and there is a defect when the ratio is 10% or more. In this case, as the reference value, for example, a contrast value of a sample whose quality has been confirmed to be good, an appropriate value obtained from accumulated data, or the like can be used. The ratio [%] of the difference between the detection value and the reference value is obtained by the following formula.

(Ratio of Difference between Detection Value and Reference Value [%])=(|(Reference Value)−(Detection Value)|)/(Reference Value)×100

### Embodiment 1-2

A three-dimensional fabrication method of a material extrusion deposition type (FDM) in which the chromaticity of the surface of a three-dimensional fabricated object in the middle of fabrication is detected in situ by a three-dimensional fabrication apparatus including a two-dimensional color luminance meter as a detector will be described.

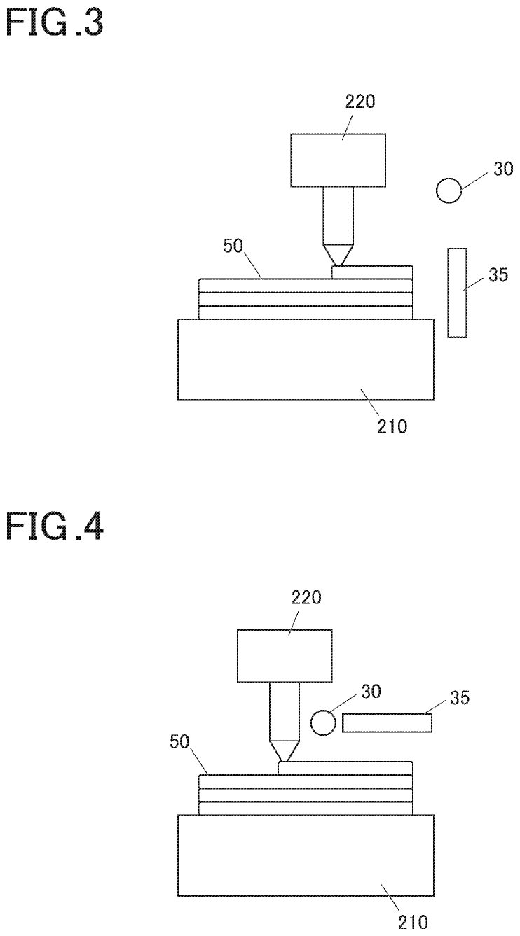

FIG. 3 is a schematic diagram of a three-dimensional fabrication apparatus of a material extrusion deposition type including a two-dimensional color luminance meter as the detector. Illustration of a support and the like for each component is omitted. FIG. 3 illustrates the main body section having the same configuration as that illustrated in FIG. 2, the two-dimensional color luminance meter 35 disposed facing a side surface thereof, and a standard light source 30 that irradiates the three-dimensional fabricated object 50 with light.

In the example illustrated in FIG. 3, one two-dimensional color luminance meter 35 is illustrated, but the number is not particularly limited, and a necessary number of the two-dimensional color luminance meters 35 can be arranged according to the shape or the like of the three-dimensional fabricated object 50. In order to detect the chromaticity of the upper surface of the three-dimensional fabricated object 50, a two-dimensional color luminance meter 35 may be disposed above the upper surface of the three-dimensional fabricated object 50 as illustrated in FIG. 4. Furthermore, the arrangement facing the side surface and the arrangement above the upper surface can be combined.

The position of the two-dimensional color luminance meter 35 can be adjusted according to the region to be detected of the three-dimensional fabricated object.

When the two-dimensional color luminance meter 35 is disposed facing the side surface, the chromaticity of the side surface of the three-dimensional fabricated object 50 can be detected, and in particular, it is suitable for detecting the chromaticity of the interlayer end portion.

When the two-dimensional color luminance meter 35 is disposed above the upper surface, the chromaticity of the upper surface of the three-dimensional fabricated object 50 can be detected, which is suitable for detecting the chromaticity of the surface of a layer on which the next layer of the three-dimensional fabricated object in the middle of fabrication is not yet laminated.

In a case where the detection is performed from the side surface, the detection may be performed layer by layer, or may be performed collectively after a plurality of layers are formed. In a case where the detection is performed from the upper surface, since the detection is performed only on the outermost surface, it is necessary to perform the detection for each layer.

Since a difference in the detected chromaticity occurs in a part of the three-dimensional fabricated object having a difference in surface condition, it can be determined that the surface condition is not uniform when the chromaticity is uneven in the detection region. For example, when it is visually recognized that layered unevenness in chromaticity is present in the image in which the chromaticity detected from the side surface is mapped, it can be determined that an abnormality occurs between layers or in a certain layer itself.

In addition, it is also possible to determine that the surface state is not uniform from the difference between the chromaticity values in the detection region. “Chromaticity” that can be detected by the two-dimensional color luminance meter is a value defined at a point where a straight line connecting a certain point and an origin intersects a plane satisfying X+Y+Z=1 in a CIE-XYZ color system in which a color space is represented by an XYZ coordinate system. That is, the chromaticity that can be detected by the two-dimensional color luminance meter is represented by an X value, a Y value, and a Z value. For example, by using the X value among these, there is also a method of determining that the surface state is not uniform when an X value difference, the difference between the maximum X value and the minimum Y value in the detection region, is large. Further, in this case, not only the X value difference but also the Y value difference and the Z value difference are obtained in the same manner, whereby more accurate determination can be made.

Alternatively, instead of obtaining a difference within a certain detection region, it is possible to determine the presence or absence of an abnormality by obtaining a difference between an average of the X values and the like within the detection region and an optionally set reference value. For example, according to the evaluation criterion, it is possible to determine that there is no abnormality in a case where the difference between the detection value of the average X value and the reference value is less than 0.005, and that there is abnormality in a case where the difference is 0.01 or more. In this case, as the reference value, for example, an average X value of samples for which it has been confirmed that the quality is good, an appropriate value obtained from accumulated data, or the like can be used.

### Embodiment 1-3

A description will be given of a three-dimensional fabrication method using a material extrusion deposition (FDM) method in which a dielectric constant of a three-dimensional fabricated object in the middle of fabrication is detected in situ by a three-dimensional fabrication apparatus including a reflection frequency analyzer with a tag as a detector.

Here, the “reflection frequency analyzer with a tag” refers to a reflection frequency analyzer of a type using a chipless radio frequency identifier (RFID) tag among reflection frequency analyzers. It is distinguished from a “reflection frequency analyzer without a tag” that is not a device of a type not using a chipless RFID tag described later. Note that the simple term “reflection frequency analyzer” includes both of them.

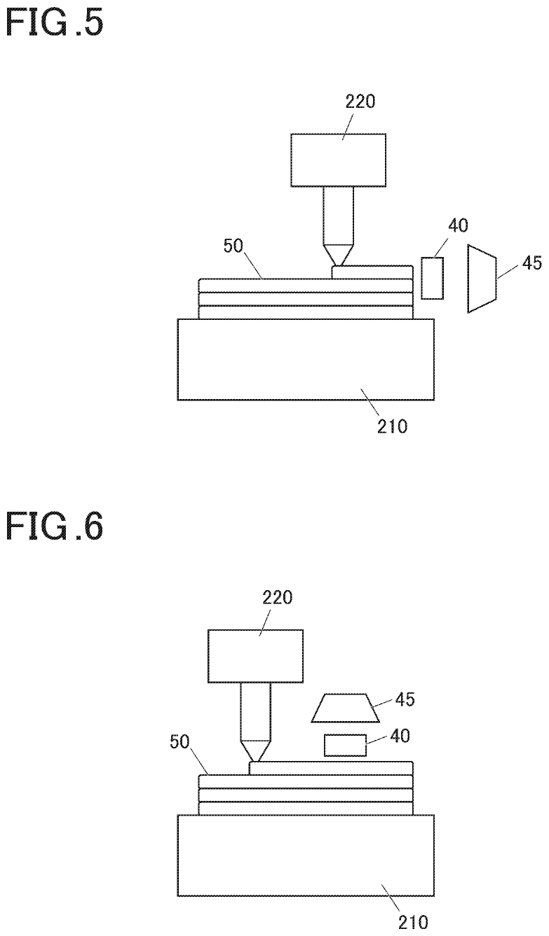

FIG. 5 is a schematic diagram of a material extrusion deposition type three-dimensional fabrication apparatus including a reflection frequency analyzer with a tag as a detector. Illustration of a support and the like for each component is omitted. FIG. 5 illustrates a main body section having the same configuration as that illustrated in FIG. 2, a chipless RFID tag 40 disposed facing a side surface thereof, and an electromagnetic wave transceiver 45 that transmits and receives electromagnetic waves to and from the chipless RFID tag 40.

The chipless RFID tag 40 has one or a plurality of resonance elements which resonate when irradiated with an electromagnetic wave of a predetermined frequency. The chipless RFID tag 40 has a reflection characteristic of absorbing an electromagnetic wave having a frequency matching the resonance frequency of each of the plurality of resonance elements and reflecting an electromagnetic wave having a frequency other than the resonance frequency when irradiated with the electromagnetic wave. Furthermore, the reflected wave changes due to a wavelength shortening effect due to a dielectric constant of an object located within a range of about 5 mm from the resonance element.

The reflection frequency analyzer with a tag of the present embodiment utilizes a characteristic of a chipless RFID tag that a reflected wave changes due to a dielectric constant of an object near the resonance element. In a case in which a three-dimensional fabricated object has a defect such as a step on the surface between layers or an internal void or crack, there is a difference in dielectric constant between a portion with the defect and a portion without the defect. The change in the resonance frequency of the chipless RFID tag caused by the difference in the dielectric constant is detected by analyzing the reflected wave of the chipless RFID tag.

That is, the difference in the dielectric constant of the three-dimensional fabricated object can be indirectly detected by detecting the difference in the resonance frequency of the chipless RFID tag due to the difference in the dielectric constant of the three-dimensional fabricated object in this method.

Hereinafter, the detection method will be specifically described.

A chipless RFID tag 40 is arranged within 5 mm from a part to be detected of a three-dimensional fabricated object 50 in the middle of fabrication. The chipless RFID tag is irradiated with electromagnetic waves in a certain frequency band (for example, 6 to 12 GHz) from the electromagnetic wave transceiver 45, and the reflection intensity [dB/MHz] at each of the frequencies is detected.

A spectrum with the frequency [GHz] as the X-axis and the reflection intensity [dB/MHz] as the Y-axis is created, and the frequency at the peak top (lowest point of a peak convex to the negative side) is read from the created spectrum. The frequency of this peak top is the resonance frequency of the chipless RFID tag.

By comparing the resonance frequency with a reference value that is optionally set, it is possible to determine whether or not the difference in dielectric constant of the three-dimensional fabricated object that contributes to the difference in resonance frequency, that is, a defect such as a step on the surface or a void inside the three-dimensional fabricated object, is within an allowable range. According to the evaluation criterion in the determination, for example, there is no defect when the peak shift ratio PS is less than 5%, and there is a defect when the peak shift ratio PS is 5% or more. The peak shift ratio PS [%] is obtained by the following expression from a detection value of a resonance frequency and a reference value.

PS[%]=(|(Reference Value [GHz])−(Detected Resonant Frequency [GHz])|)/(Reference Value [GHz])×100

In this case, the reference value may be, for example, the resonance frequency of the chipless RFID tag at the time of detection of a sample whose quality has been confirmed to be good, an appropriate value obtained from accumulated data, or the like. In the case where the resonance frequency of the chipless RFID tag at the time of detection of a sample whose quality has been confirmed to be good is used as the reference value, and when there are a plurality of resonance frequencies, a plurality of peak shift ratios PS [%] are calculated in the same manner. In such a case, it is possible to set the highest peak shift ratio PS [%] as an evaluation target.

The chipless RFID tag 40 and the electromagnetic wave transceiver 45 can be disposed facing a side surface of the three-dimensional fabricated object 50 as illustrated in FIG. 5. These can also be arranged above the upper surface of the three-dimensional fabricated object 50 as illustrated in FIG. 6.

The embodiment in which the chipless RFID tag 40 and the electromagnetic wave transceiver 45 are disposed facing the side surface is suitable for detecting a step on the side surface of the three-dimensional fabricated object 50 or a defect such as a void or a crack therein.

The embodiment in which the chipless RFID tag 40 and the electromagnetic wave transceiver 45 are disposed above the upper surface is suitable for detecting a defect in a portion that is difficult to detect from a side surface.

In a case where the detection is performed from the side surface, the detection may be performed layer by layer, or may be performed collectively after a plurality of layers are formed. In the detection using the reflection frequency analyzer with a tag, even in a case where detection is performed from the upper surface, detection can be performed at an inside of one or two layers from the outermost surface.

### Embodiment 1-4

A three-dimensional fabrication method by a material extrusion deposition method (FDM) in which the electromagnetic wave reflection intensity or the electromagnetic wave absorption intensity of a three-dimensional fabricated object in the middle of fabrication is detected in situ by a three-dimensional fabrication apparatus including a reflection frequency analyzer without a tag as a detector will be described. This method is suitable for a case where the three-dimensional fabricated object contains a conductive material such as carbon nanofiber.

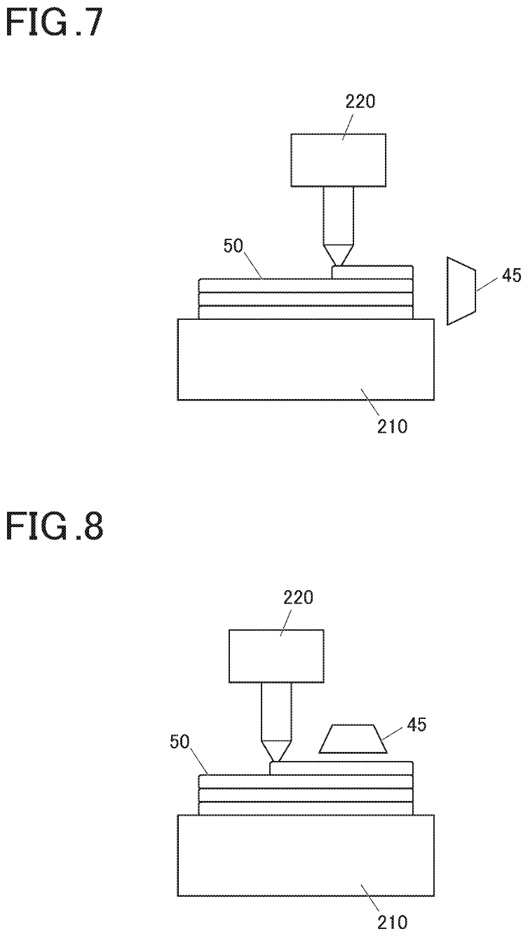

FIG. 7 is a schematic diagram of a three-dimensional fabrication apparatus of a material extrusion deposition type including a reflection frequency analyzer without a tag as a detector. Illustration of a support and the like for each component is omitted. FIG. 7 illustrates a main body section having the same configuration as that illustrated in FIG. 2 and the electromagnetic wave transceiver 45 (reflection frequency analyzer without a tag) arranged facing a side surface thereof.

In the reflection frequency analyzer without a tag, the electromagnetic transceiver 45 irradiates the three-dimensional fabricated object 50 with electromagnetic waves of a certain frequency band (for example, 6 to 11 GHz). The device receives reflected waves reflected from the conductive material contained in the three-dimensional fabricated object 50 with the electromagnetic wave transceiver 45.

In a case where a three-dimensional fabricated object has a defect such as a step on the surface between layers or an internal void, there is a difference in electromagnetic wave absorption intensity between a portion with the defect and a portion without the defect. By analyzing the reflection intensity using this method, the difference in the electromagnetic wave absorption intensity of the three-dimensional fabricated object is detected.

Hereinafter, the detection method will be specifically described.

A portion to be detected of the three-dimensional fabricated object 50 in the course of fabrication is irradiated with electromagnetic waves in a certain frequency band (e.g., 6 to 11 GHz) from the electromagnetic transceiver 45. The reflection intensity [dB/MHz] at each frequency is detected.

A spectrum with the frequency [GHz] as the X-axis and the reflection intensity [dB/MHz] as the Y-axis is created. From the created spectrum, the reflection intensity is integrated with respect to frequency to obtain an integrated reflection intensity in a certain frequency band.

By comparing the integrated reflection intensity with a reference value which is optionally set, it is possible to determine whether or not the defect is within an allowable range. According to the evaluation criterion in the determination, for example, there is no defect when the ratio [%] of the difference between the detection value of the integrated reflection intensity and the reference value is less than 10%, and there is a defect when the ratio [%] is 10% or more. In this case, the reference value can be, for example, the integrated reflection intensity of a sample whose quality has been confirmed to be good, an appropriate value obtained from accumulated data, or the like. The ratio [%] of the difference between the detection value and the reference value is obtained by the following formula.

(Ratio of Difference between Detection Value and Reference Value [%])=(|(Reference Value)−(Detection Value)|)/(Reference Value)×100

The electromagnetic wave transceiver 45 of the reflection frequency analyzer without a tag may be disposed facing a side surface of the three-dimensional fabricated object 50 as illustrated in FIG. 7, or may be disposed above an upper surface of the three-dimensional fabricated object 50 as illustrated in FIG. 8.

The electromagnetic wave transceiver 45 disposed facing the side surface is suitable for detecting a defect such as a step on the side surface of the three-dimensional fabricated object 50 or a void inside the three-dimensional fabricated object 50.

The electromagnetic wave transceiver 45 disposed above the upper surface is suitable for detecting a defect in a portion that is difficult to detect from the side surface.

In a case where the detection is performed from the side surface, the detection may be performed layer by layer, or may be performed collectively after a plurality of layers are formed. In the detection using the reflection frequency analyzer without a tag, even in a case where detection is performed from the upper surface, detection can be performed at an inside of one or two layers from the outermost surface.

### Embodiment 2

In Embodiment 2, a three-dimensional fabrication method and a three-dimensional fabrication apparatus for detecting in situ data relating to physical or chemical characteristics of a three-dimensional fabricated object in the middle of three-dimensional fabrication by powder sintering lamination (SLS) will be described.

### [Powder Sintering Lamination Method]

First, the powder sintering lamination method (SLS) will be described.

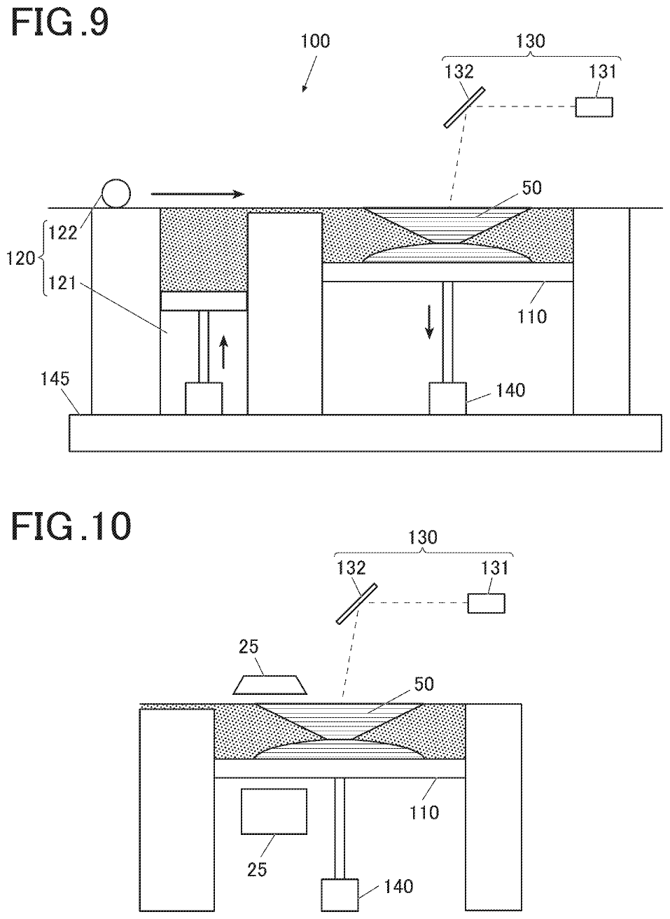

FIG. 9 is an example of the configuration of a three-dimensional fabrication apparatus of a powder sintering lamination type. Illustration of a support and the like for each component is omitted. The powder sintering lamination type three-dimensional fabrication apparatus 100 illustrated in FIG. 9 includes a fabrication stage 110, a thin layer former 120, a laser irradiator 130, a stage support 140, and a base 145. The fabrication stage 110 is positioned in the opening. The thin layer former 120 forms a thin layer of a powder material on the fabrication stage. The laser irradiator 130 includes a laser light source 131 and a galvanometer mirror 132a, and emits a laser beam to the thin layer. The stage support 140 supports the fabrication stage 110 such that the vertical position of the fabrication stage 110 changes. The base 145 supports the aforementioned components.

On the fabrication stage 110, a fabrication material layer is formed by formation of a thin layer by the thin layer former 120 and irradiation of a laser beam by the laser irradiator 130. By laminating the fabrication material layers, the three-dimensional fabricated object 50 is fabricated.

The thin layer former 120 can be configured to include, for example, a powder supplier 121 and a recoater 122a. The powder supplier 121 includes an opening, a powder material storage, and a supply piston. The opening has an edge that is substantially coplanar in a horizontal direction with an edge of the opening through which the fabrication stage 110 moves up and down. The powder material storage extends downward in the vertical direction from the opening. The supply piston is provided at a bottom of the powder material storage and moves up and down in the opening. The recoater 122a lays the supplied powder material flat on the fabrication stage 110 to form a thin layer of the powder material.

The powder supplier 121 may include a powder material storage provided above the fabrication stage 110 in the vertical direction and a nozzle, and may be configured to eject the powder material onto the same plane as the fabrication stage in the horizontal direction.

Hereinafter, embodiments of a three-dimensional fabrication method and a three-dimensional fabrication apparatus to which each detection method is applied in the powder sintering lamination method will be described.

### Embodiment 2-1

A three-dimensional fabrication method by powder sintering lamination method (SLS) in which an X-ray interference image of a three-dimensional fabricated object in the middle of fabrication is detected in situ by a three-dimensional fabrication apparatus including an X-ray Talbot-Lau imaging device as a detector will be described.

FIG. 10 is a schematic diagram of a three-dimensional fabrication apparatus of a powder sintering lamination type including an X-ray Talbot-Lau imaging device as a detector. Illustration of a support and the like for each component is omitted. In FIG. 10, a main body section for fabricating a three-dimensional fabricated object has the same configuration as that of the three-dimensional fabrication apparatus 100 of the powder sintering lamination method illustrated in FIG. 9. In the present embodiment, the X-ray source 20 is disposed above the upper surface of the main body section, and the X-ray detector 25 is disposed below the lower surface with the three-dimensional fabricated object 50 interposed therebetween. In the source grating, the first grating, and the second grating, a plurality of slits are aligned in a direction orthogonal to an irradiation axis direction of X-rays emitted from the X-ray source. Note that as with Embodiment 1-1, an X-ray Talbot imaging device can also be adopted.

The X-ray Talbot-Lau imaging device including the X-ray source 20 and the X-ray detector 25 can be positionally adjusted according to a region of the three-dimensional fabricated object 50 to be detected.

Other detection methods and the like are the same as those in Embodiment 1-1. In the case of detection from the upper surface, the contrast value of one layer can be obtained by subtracting the contrast value of the differential phase image of a layer surface one layer below the layer to be detected from the contrast value of the differential phase image of the surface of the layer to be detected.

For example, the same evaluation criterion as that used in Embodiment 1-1 can be used.

### Embodiment 2-2

A three-dimensional fabrication method using a powder sintering lamination method (SLS) in which the chromaticity of the surface of a three-dimensional fabricated object in the middle of fabrication is detected in situ by a three-dimensional fabrication apparatus including a two-dimensional color luminance meter as a detector will be described.

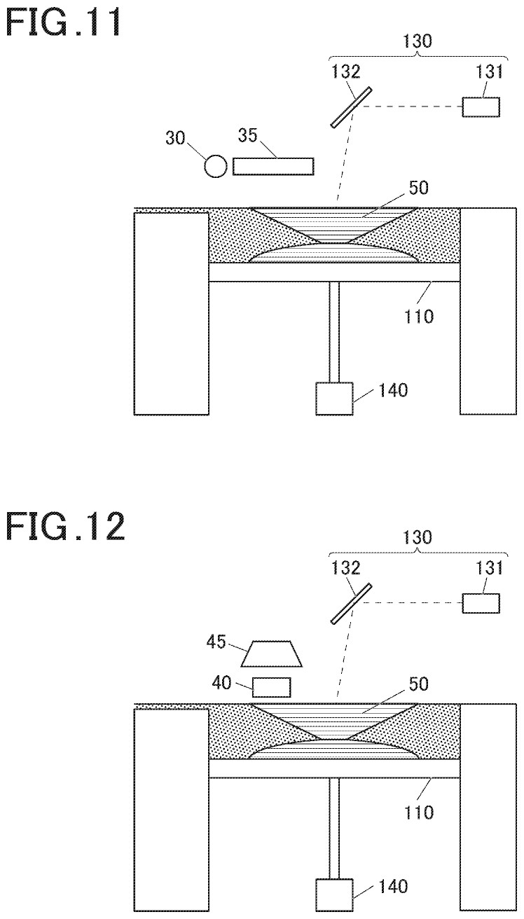

FIG. 11 is a schematic diagram of a three-dimensional fabrication apparatus of a powder sintering lamination type including a two-dimensional color luminance meter as a detector. Illustration of a support and the like for each component is omitted. FIG. 11 illustrates a main body section similar to that of the three-dimensional fabrication apparatus 100 using the powder sintering lamination method illustrated in FIG. 9, a two-dimensional color luminance meter 35 disposed above the upper surface of the main body section, and a standard light source 30 that irradiates the three-dimensional fabricated object 50 with light.

Other detection methods and the like are the same as those in Embodiment 1-2.

For example, the same evaluation criterion as that used in Embodiment 1-2 can be used.

### Embodiment 2-3

A three-dimensional fabrication method using a powder sintering lamination (SLS) method in which a dielectric constant of a three-dimensional fabricated object in the middle of fabrication is detected in situ by a three-dimensional fabrication apparatus including a reflection frequency analyzer with a tag as a detector will be described.

FIG. 12 is a schematic diagram of a three-dimensional fabrication apparatus of a powder sintering lamination type including a reflection frequency analyzer with a tag as a detector. Illustration of a support and the like for each component is omitted. FIG. 12 illustrates a main body section similar to that of the three-dimensional fabrication apparatus 100 using the powder sintering lamination method illustrated in FIG. 9, a chipless RFID tag 40 disposed above an upper surface of the main body section, and an electromagnetic wave transceiver 45 that transmits and receives electromagnetic waves to and from the chipless RFID tag 40.

Other detection methods and the like are the same as those in Embodiment 1-3.

For example, the same evaluation criterion as that used in Embodiment 1-3 can be used.

### Embodiment 2-4

A three-dimensional fabrication method using a powder sintering lamination (SLS) method in which the electromagnetic wave reflection intensity or the electromagnetic wave absorption intensity of a three-dimensional fabricated object in the middle of fabrication is detected in situ by a three-dimensional fabrication apparatus including a reflection frequency analyzer without a tag as a detector will be described. This method is suitable for a case where the three-dimensional fabricated object contains a conductive material such as carbon nanofiber.

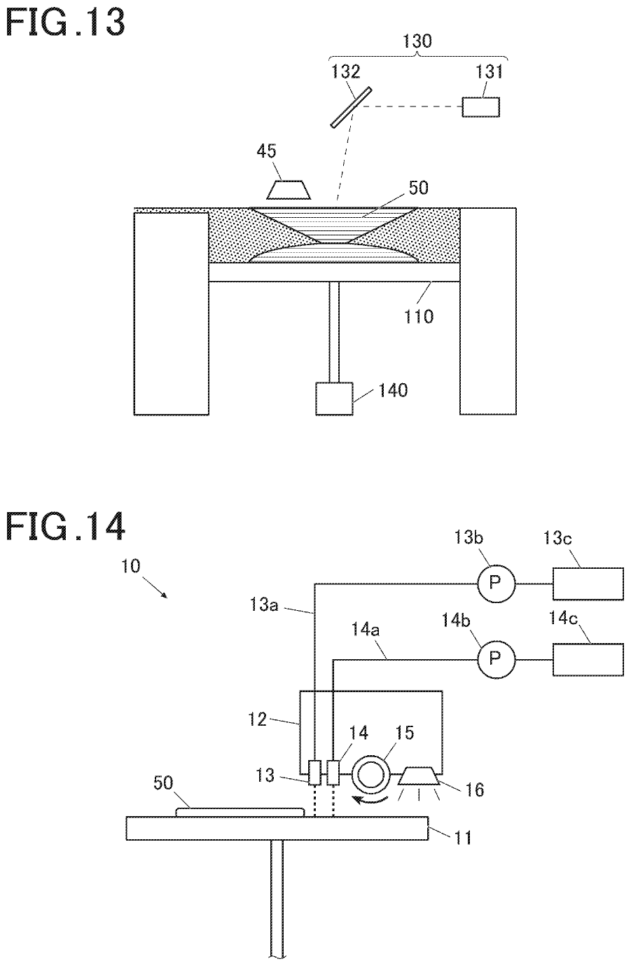

FIG. 13 is a schematic diagram of a three-dimensional fabrication apparatus of a powder sintering lamination type including a reflection frequency analyzer without a tag as a detector. Illustration of a support and the like for each component is omitted. FIG. 13 illustrates a main body section similar to the three-dimensional fabrication apparatus 100 using the powder sintering lamination method illustrated in FIG. 9 and an electromagnetic wave transceiver 45 (a reflection frequency analyzer without a tag) disposed above an upper surface of the main body section.

Other detection methods and the like are the same as those in Embodiments 1 to 4.

For example, the same evaluation criterion as that used in Embodiments 1 to 4 can be used.

### Embodiment 3

In Embodiment 3, a three-dimensional fabrication method and a three-dimensional fabrication apparatus in which data relating to physical or chemical characteristics of a three-dimensional fabricated object is detected in situ in the middle of fabrication in three-dimensional fabrication by a material jetting method (MJ) will be described.

### [Material Jetting Method]

First, the material jetting method (MJ) will be described.

FIG. 14 illustrates a configuration example of a three-dimensional fabrication apparatus of a material jetting type. Illustration of a support and the like for each component is omitted. A three-dimensional fabrication apparatus of a material jetting type 10 illustrated in FIG. 14 includes a stage 11 and an inkjet 12. The stage 11 includes driving means (not illustrated) that drives the stage 11 up and down. The three-dimensional fabricated object 50 is placed on the stage 11. The inkjet 12 is disposed on a rail (not shown) so as to be movable left and right, and ejects the ink composition for a model material and a support material.

The inkjet 12 includes an inkjet head 13 for a model material, an inkjet head 14 for a support material, a layer thickness adjusting roller 15, and a light irradiator 16. The inkjet head 13 for a model material communicates with a pump 13a and an ink tank 13b via a pipe 13c. The inkjet head 14 for a support material communicates with a pump 14a and an ink tank 14b via a pipe 14c.

The ink composition for a model material and the ink composition for a support material are photocured. In a case where the actinic rays for photocuring are ultraviolet rays, examples of the actinic ray irradiator (ultraviolet irradiator) include a fluorescent tube (a low-pressure mercury lamp or a germicidal lamp), a cold cathode tube, an ultraviolet laser, a mercury lamp, a metal halide lamp, an LED, and the like. Mercury lamps are, for example, low-pressure, medium-pressure or high-pressure with operating pressures of a several hundreds Pa to 1 MPa. In light of curability, an ultraviolet irradiator that emits ultraviolet rays having an intensity of illuminance of 100 mW/cm² or more is preferable. Specific examples of the ultraviolet irradiator include a high-pressure mercury lamp, a metal halide lamp, and an LED. An LED is more preferable in terms of low power consumption. In particular, a water-cooled LED of 395 nm manufactured by Phoseon Technology can be used.

Hereinafter, embodiments of a three-dimensional fabrication method and a three-dimensional fabrication apparatus to which each detection method is applied in the material jetting method will be described.

### Embodiment 3-1

A three-dimensional fabrication method using a material jetting method (MJ) in which an X-ray interference image of a three-dimensional fabricated object in the middle of fabrication is detected in situ by a three-dimensional fabrication apparatus including an X-ray Talbot-Lau imaging device as a detector will be described.

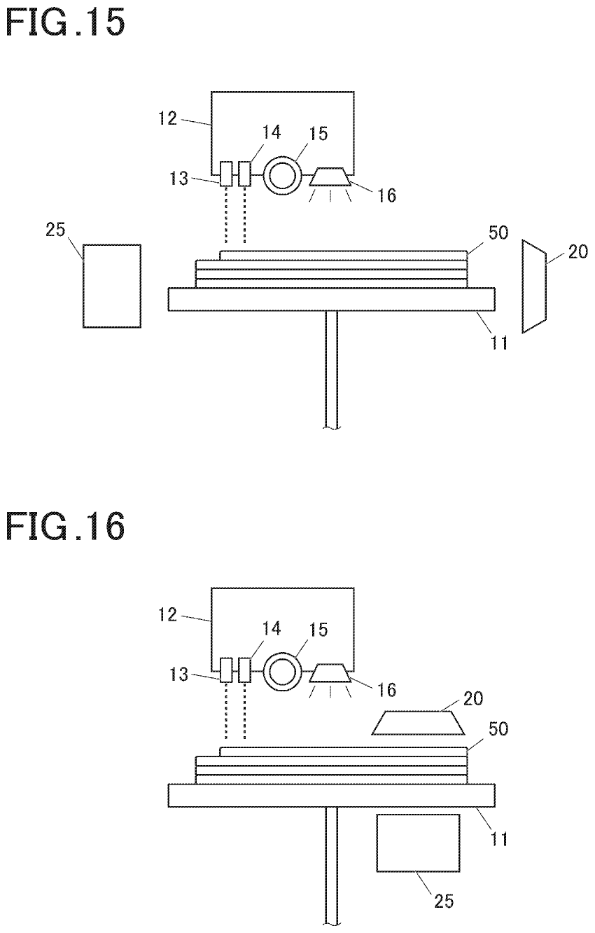

FIG. 15 is a schematic diagram of a three-dimensional fabrication apparatus of a material jetting type including an X-ray Talbot-Lau imaging device as a detector. Illustration of a support and the like for each component is omitted. In FIG. 15, a main section for fabricating a three-dimensional fabricated object has the same configuration as that of the three-dimensional fabrication apparatus 10 of a material jetting type illustrated in FIG. 14. In the present embodiment, the X-ray source 20 is disposed facing one side surface of the main body section, and the X-ray detector 25 is disposed facing the other side surface with the three-dimensional fabricated object 50 interposed therebetween. The X-ray source 20 includes a source grating, and the X-ray detector 25 includes a first grating and a second grating. In the source grating, the first grating, and the second grating, a plurality of slits are aligned in a direction orthogonal to an irradiation axis direction of X-rays emitted from the X-ray source. Note that as with Embodiment 1-1, an X-ray Talbot imaging device can also be adopted.

As illustrated in FIG. 16, it is also possible to arrange the X-ray source 20 above the upper surface of the main body section and arrange the X-ray detector 25 below the lower surface with the three-dimensional fabricated object 50 interposed therebetween.

The X-ray Talbot-Lau imaging device including the X-ray source 20 and the X-ray detector 25 can be positionally adjusted according to a region of the three-dimensional fabricated object 50 to be detected.

Other detection methods and the like are the same as those in Embodiment 1-1. In the case of detection from the upper surface, the contrast value of one layer can be obtained by subtracting the contrast value of the differential phase image of a layer surface one layer below the layer to be detected from the contrast value of the differential phase image of the surface of the layer to be detected.

For example, the same evaluation criterion as that used in Embodiment 1-1 can be used.

### Embodiment 3-2

A three-dimensional fabrication method using a material jetting method (MJ) in which the chromaticity of the surface of a three-dimensional fabricated object in the middle of fabrication is detected in situ by a three-dimensional fabrication apparatus including a two-dimensional color luminance meter as a detector will be described.

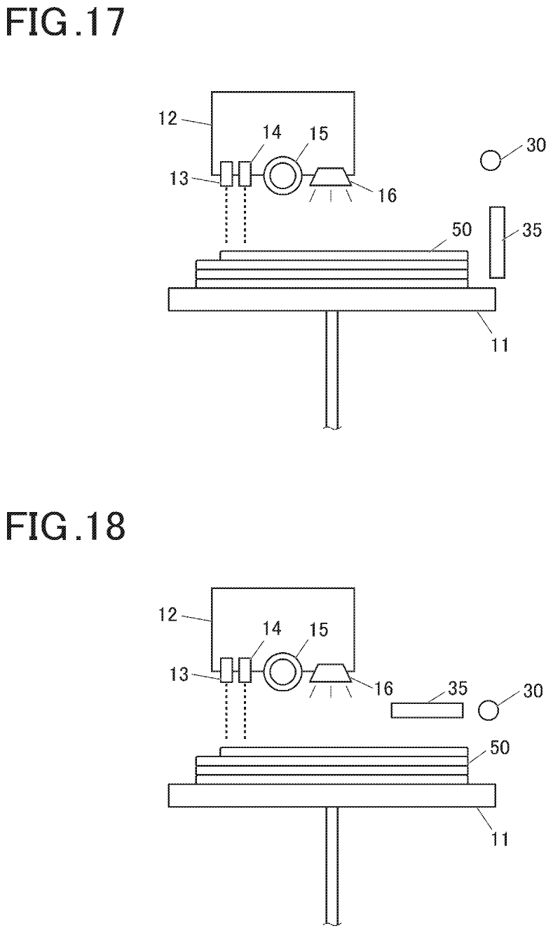

FIG. 17 is a schematic diagram of a material jetting type three-dimensional fabrication apparatus including a two-dimensional color luminance meter as a detector. Illustration of a support and the like for each component is omitted. FIG. 17 illustrates a main body section similar to that of the three-dimensional fabrication apparatus 10 of a material jetting type illustrated in FIG. 14, a two-dimensional color luminance meter 35 disposed above an upper surface of the main body section, and a standard light source 30 that irradiates the three-dimensional fabricated object 50 with light.

In order to detect the chromaticity of the upper surface of the three-dimensional fabricated object 50, a two-dimensional color luminance meter 35 may be disposed above the upper surface of the three-dimensional fabricated object 50 as illustrated in FIG. 18. Furthermore, the arrangement facing the side surface and the arrangement above the upper surface can be combined.

Other detection methods and the like are the same as those in Embodiment 1-2.

For example, the same evaluation criterion as that used in Embodiment 1-2 can be used.

### Embodiment 3-3

A three-dimensional fabrication method using a material jetting method (MJ) in which a dielectric constant of a three-dimensional fabricated object in the middle of fabrication is detected in situ by a three-dimensional fabrication apparatus including a reflection frequency analyzer with a tag as a detector will be described.

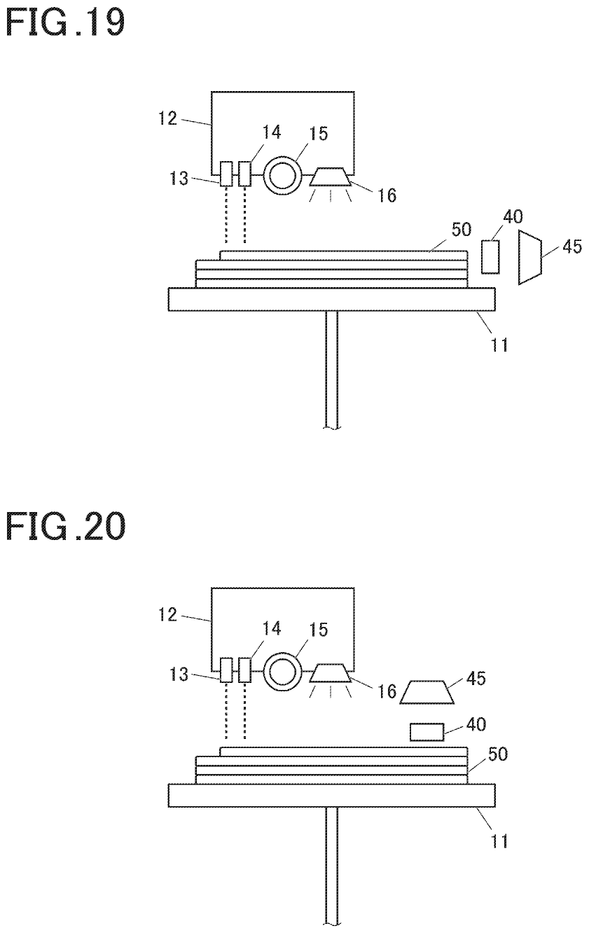

FIG. 19 is a schematic diagram of a three-dimensional fabrication apparatus of a material jetting type including a reflection frequency analyzer with a tag as a detector. Illustration of a support and the like for each component is omitted. FIG. 19 illustrates a main body section similar to that of the three-dimensional fabrication apparatus 10 of a material jetting type illustrated in FIG. 14, a chipless RFID tag 40 arranged above an upper surface of the main body section, and an electromagnetic wave transceiver 45 that transmits and receives electromagnetic waves to and from the chipless RFID tag 40.

The chipless RFID tag 40 and the electromagnetic wave transceiver 45 can be disposed facing a side surface of the three-dimensional fabricated object 50 as shown in FIG. 19. These can also be arranged above the upper surface of the three-dimensional fabricated object 50 as illustrated in FIG. 20.

Other detection methods and the like are the same as those in Embodiment 1-3.

For example, the same evaluation criterion as that used in Embodiment 1-3 can be used.

### Embodiment 4

In Embodiment 4, a three-dimensional fabrication method and a three-dimensional fabrication apparatus in which data regarding physical or chemical characteristics of a three-dimensional fabricated object is detected in situ in the middle of three-dimensional fabrication by stereolithography (SLA) will be described.

### [Stereolithography] First, the Stereolithography (SLA) Will be Described.

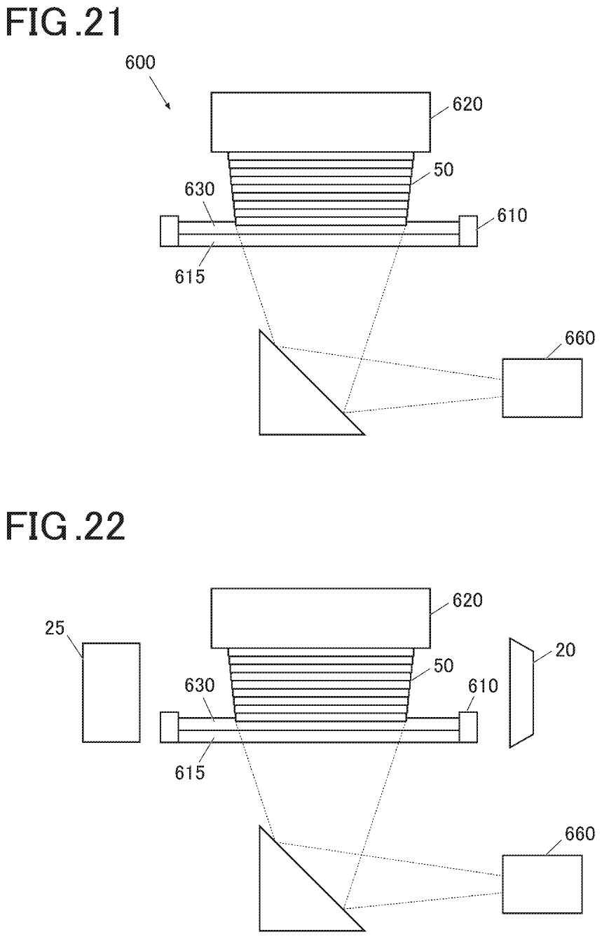

FIG. 21 shows an example of the configuration of a three-dimensional fabrication apparatus of a stereolithography type. Illustration of a support and the like for each component is omitted. A three-dimensional fabrication apparatus 600 of a stereolithography type illustrated in FIG. 21 includes a fabrication tank 610 that can store a liquid photocurable composition 630, a fabrication stage 620 that can move back and forth vertically (in the depth direction), and a light irradiator 660 for emitting light. The fabrication tank 610 has a window 615 in the bottom portion thereof. The light emitted from the light irradiator 660 is transmitted through the window 615.

The photocurable composition 630 filled in the fabrication tank 610 is irradiated with light from below to form a layer having a certain shape. Each time one layer is formed, the fabrication stage 620 is raised by one layer, and is irradiated with light to form the next layer. By repeating this, the three-dimensional fabricated object 50 is fabricated.

Although the DLP method is illustrated in FIG. 21, a laser method may be used. The DLP method is a method in which a photocurable composition is cured by irradiation with light in a plane (one-shot exposure). The laser method is a method in which the photocurable composition is cured by point irradiation with light (laser exposure).

### Embodiment 4-1

A three-dimensional fabrication method using stereolithography (SLA) in which an X-ray interference image of a three-dimensional fabricated object in the middle of fabrication is detected in situ by a three-dimensional fabrication apparatus including an X-ray Talbot-Lau imaging device as a detector will be described.

FIG. 22 is a schematic diagram of a three-dimensional fabrication apparatus of a stereolithography type including an X-ray Talbot-Lau imaging device as a detector. Illustration of a support and the like for each component is omitted. In FIG. 22, a main body section for forming a three-dimensional fabricated object has the same configuration as that of the three-dimensional fabrication apparatus 600 of a stereolithography type illustrated in FIG. 21. In the present embodiment, the X-ray source 20 is disposed facing one side surface of the main body section, and the X-ray detector 25 is disposed facing the other side surface with the three-dimensional fabricated object 50 interposed therebetween. The X-ray source 20 includes a source grating, and the X-ray detector 25 includes a first grating and a second grating. In the source grating, the first grating, and the second grating, a plurality of slits are aligned in a direction orthogonal to an irradiation axis direction of X-rays emitted from the X-ray source. Note that as with Embodiment 1-1, an X-ray Talbot imaging device can also be adopted.

The X-ray Talbot-Lau imaging device including the X-ray source 20 and the X-ray detector 25 can be positionally adjusted according to a region of the three-dimensional fabricated object 50 to be detected.

Other detection methods and the like are the same as those in Embodiment 1-1.

For example, the same evaluation criterion as that used in Embodiment 1-1 can be used.

### Embodiment 4-2

A three-dimensional fabrication method using a stereolithography (SLA) method in which the chromaticity of the surface of a three-dimensional fabricated object in the middle of fabrication is detected in situ by a three-dimensional fabrication apparatus including a two-dimensional color luminance meter as a detector will be described.

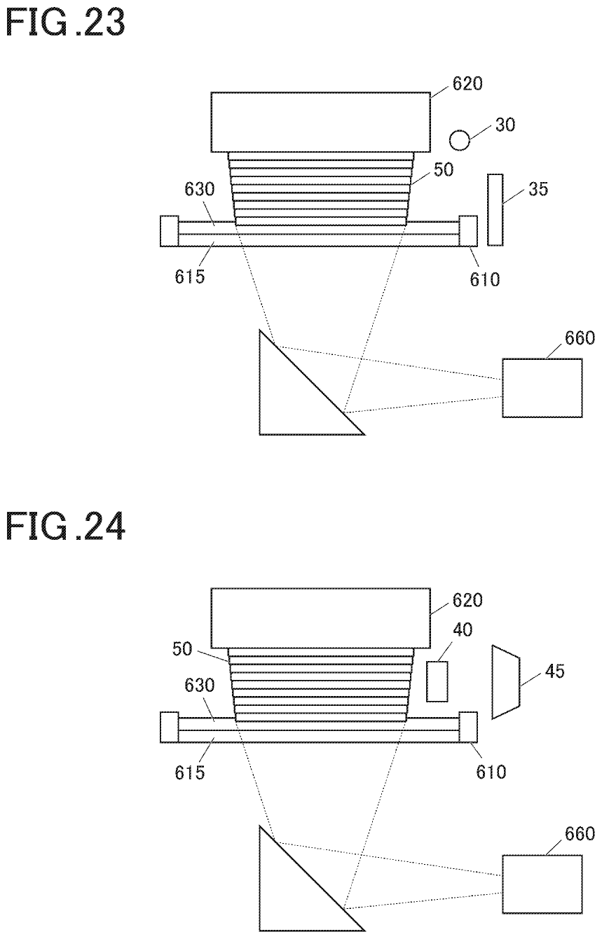

FIG. 23 is a schematic diagram of a three-dimensional fabrication apparatus of a stereolithography type including a two-dimensional color luminance meter as a detector. Illustration of a support and the like for each component is omitted. FIG. 23 illustrates a main body section similar to that of the three-dimensional fabrication apparatus 600 of a stereolithography type illustrated in FIG. 21, a two-dimensional color luminance meter 35 disposed facing a side surface of the main body section, and a standard light source 30 that irradiates the three-dimensional fabricated object 50 with light.

Other detection methods and the like are the same as those in Embodiment 1-2.

For example, the same evaluation criterion as that used in Embodiment 1-2 can be used.

### Embodiment 4-3

A three-dimensional fabrication method using a stereolithography (SLA) in which a dielectric constant of a three-dimensional fabricated object in the middle of fabrication is detected in situ by a three-dimensional fabrication apparatus including a reflection frequency analyzer with a tag as a detector will be described.

FIG. 24 is a schematic diagram of a three-dimensional fabrication apparatus of a stereolithography type including a reflection frequency analyzer with a tag as a detector. Illustration of a support and the like for each component is omitted. FIG. 24 illustrates a main body section similar to that of the three-dimensional fabrication apparatus 600 of a stereolithography type illustrated in FIG. 21, a chipless RFID tag 40 disposed facing a side surface of the main body section, and an electromagnetic wave transceiver 45 that transmits and receives electromagnetic waves to and from the chipless RFID tag 40.

Other detection methods and the like are the same as those in Embodiment 1-3.

For example, the same evaluation criterion as that used in Embodiment 1-3 can be used.

### Other Examples of Detection

### [Impedance Spectroscopy]

Defects such as voids and cracks in a three-dimensional fabricated object can also be detected by measuring a minute alternating current that flows when a voltage is applied. As one of the methods, for example, impedance spectroscopy can be exemplified. In the impedance spectrometry, an AC voltage is applied to a three-dimensional fabricated object in the course of fabrication at a broadband frequency, and the impedance is measured. By measuring the phase difference at this time, a defect such as a void or a crack can be detected.

### [Fluorescence Fingerprint Method]

When the thermoplastic resin used in the material extrusion deposition method (FDM) or the powder sintering lamination method (SLS) has a functional group capable of forming a covalent bond by heat or ultraviolet rays in a side chain or at a terminal portion of a resin molecule, the progress of the covalent bond formation by the functional group can be detected by the fluorescent fingerprint method. Examples of the functional group include a nitrile oxide group, a vinyl group, a thiol group, a furan ring group, a maleimide ring group, and a cinnamic acid residue. In addition, in the case of the material jetting method (MJ) or the stereolithography (SLA), the progress of the curing reaction of the photocurable resin can be similarly detected. By detecting the progress of the chemical reaction of the material as described above, it is possible to determine whether sufficient strength can be developed between the layers of the three-dimensional fabricated object.

### [Fourier Transform Infrared Spectroscopy (FTIR)]

Similar to the fluorescent fingerprint method, the progress of the covalent bond formation or the curing reaction can also be detected by Fourier transform infrared spectroscopy. By detecting the progress of the chemical reaction of the material as described above, it is possible to determine whether sufficient strength can be developed between the layers of the three-dimensional fabricated object.

### <Additional Process and Change in Fabrication Condition>

In the method for manufacturing a three-dimensional fabricated object of one or more embodiments of the present invention, an additional process or a change in the fabrication conditions may be performed in situ depending on the data regarding the detected physical or chemical characteristics. As a result, it is possible to improve the quality and reduce the number of defective products, and thus it is possible to improve the manufacturing efficiency or to manufacture a high-quality three-dimensional fabricated object.

The term “additional process” refers to a process such as heating and light irradiation, which is additionally performed on an already-fabricated part of a three-dimensional fabricated object. Furthermore, the term “change in fabrication conditions” refers to a change in fabrication conditions such as material temperature, fabrication speed, heating temperature, and irradiation energy.

As an example of the additional process, a case where a defect such as a void or a crack of a three-dimensional fabricated object in the middle of fabrication is repaired in situ in a material extrusion deposition method (FDM) or a powder sintering lamination (SLS) using a thermoplastic resin will be described.

In the case of repairing a defect detected in the above-described method using a thermoplastic resin in situ, it is effective to heat the resin around the defect by some method to bring the resin into a nearly molten state again, thereby filling the defect.

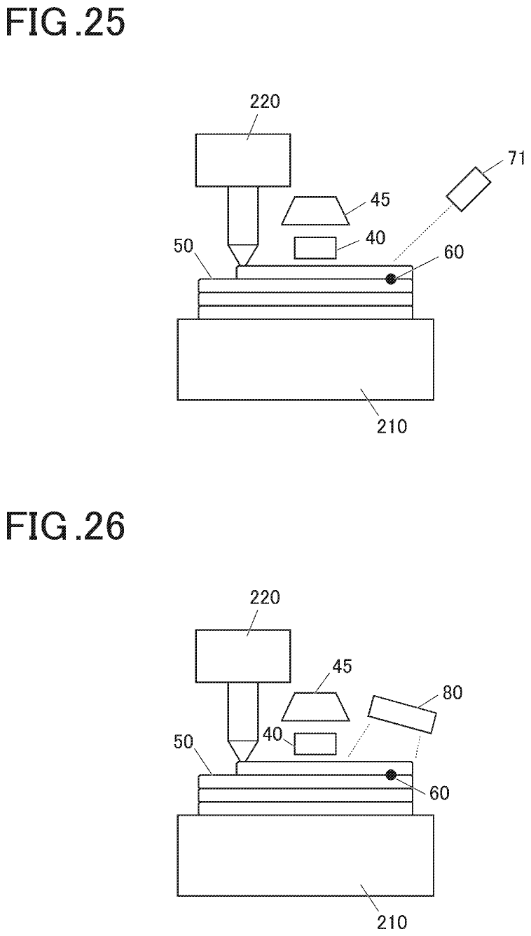

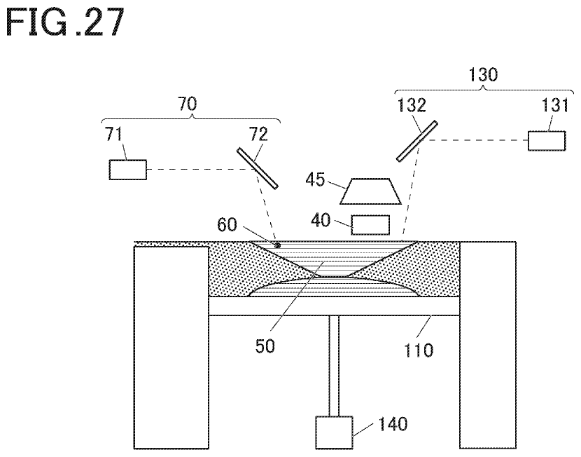

As a method of heating the resin around the defect, for example, there is a method of locally irradiating infrared rays by using an infrared laser light source or an infrared lamp (FIGS. 25 to 27). Alternatively, as a method of heating the resin around the defect, for example, there is a method of temporarily raising the temperature of the entire fabrication area.

There is another method in which, when fabricating a layer directly above a defective layer, the temperature of a nozzle is temporarily increased in the case of the material extrusion deposition method (FDM) and the laser intensity is temporarily increased in the case of the powder sintering lamination method (SLS) to laminate a resin in a state of a higher temperature than usual. As a result, heat is transferred from the high-temperature resin laminated on the upper layer to the lower layer, so that the resin around the defect is heated and the defect can be filled.

### EXAMPLE

Hereinafter, embodiments of the present invention will be specifically described with reference to Examples, but the present invention is not limited thereto. In Examples, “part(s)” or means “part(s) by mass” or “% by mass” unless otherwise specified.

### Example 1-1

An example of “Embodiment 1-1: A three-dimensional fabrication method using a material extrusion deposition method (FDM) in which an X-ray interference image of a three-dimensional fabricated object in the middle of fabrication is detected in situ by a three-dimensional fabrication apparatus including an X-ray Talbot-Lau imaging device as a detector” will be described.

According to an example of the evaluation criterion used in the present example, there is no defect in a case where the ratio of the difference between the detection value of the contrast value and the reference value is less than 10%, and there is a defect in a case where the ratio is 10% or more. Thereby, it was confirmed whether the presence or absence of a defect could be detected in the present embodiment. As the reference value, a contrast value obtained from a three-dimensional fabricated object having no defect prepared in advance was used.

A three-dimensional fabrication apparatus (having a configuration illustrated in FIG. 2) of a material extrusion deposition type (FDM) including an X-ray Talbot-Lau imaging device as a detector was used to fabricate a three-dimensional fabricated object. At this time, the three-dimensional fabricated object was fabricated under conditions in which voids were intentionally likely to occur between layers, by fabricating while the resin ejection temperature was temporarily lowered compared with that in the appropriate conditions.

As a main body section of a material extrusion deposition for fabrication a three-dimensional fabricated object, M200 manufactured by Zortrax was used. If necessary, the cover outside the main body was removed for use.

As the fabrication material, an ABS resin filament was used.

A Coolidge X-ray source was used as an X-ray source of the X-ray Talbot-Lau imaging device. A flat panel detector (FPD) was used as the X-ray detector.

A differential phase image of a part fabricated under appropriate conditions and a differential phase image of a part fabricated at a decreased resin ejection temperature were captured and generated in situ using an X-ray Talbot-Lau imaging device included in the three-dimensional fabrication apparatus. The contrast of the differential phase image was digitized and averaged, and the contrast value of each part was obtained.

The ratio of the difference between the reference value and the detection value of the contrast value of the part fabricated under the appropriate condition was 2%. On the other hand, the ratio of the difference between the reference value and the detection value of the contrast value of the part fabricated at a lower resin ejection temperature was 12%.

From this result, it was confirmed that the presence or absence of a defect can be detected in situ according to the evaluation criterion that there is no defect when the ratio of the difference between the detection value of the contrast value and the reference value is less than 10%, and there is a defect when the ratio is 10% or more.

In addition, the contrast value of each part obtained in the same manner using an independent X-ray Talbot-Lau imaging device after the completion of the fabrication was equivalent to the detection result in situ. From this result, it was confirmed that the in-situ detection of the presence or absence of a defect according to the present embodiment is not inferior to the conventional detection after the completion of the fabrication.

### Example 1-2

An example of “Embodiment 1-2: A three-dimensional fabrication method using a material extrusion deposition method (FDM) in which the chromaticity of the surface of a three-dimensional fabricated object in the middle of fabrication is detected in situ by a three-dimensional fabrication apparatus including a two-dimensional color luminance meter as a detector” will be described.

According to an example of the evaluation criterion used in the present example, there is no defect in a case where the difference between the detection value of the average X value and the reference value is less than 0.005, and there is a defect in a case where the difference is 0.01 or more. Thus, it was confirmed whether an abnormality in the surface state of a three-dimensional fabricated object can be detected in the present embodiment. As the reference value, an average X value obtained from a three-dimensional fabricated object prepared in advance and having no abnormality in its surface state was used.

A three-dimensional fabrication apparatus (having a configuration illustrated in FIG. 3) of a material extrusion deposition type (FDM) including a two-dimensional color luminance meter as a detector was used to fabricate a three-dimensional fabricated object. At this time, the three-dimensional fabricated object was fabricated under conditions in which abnormalities in the surface state were intentionally likely to occur, by fabricating while the resin ejection temperature was temporarily lowered compared with that in the appropriate conditions.

The main body section of a material extrusion deposition for fabrication of a three-dimensional fabricated object and the fabrication material were the same as those used in Example 1-1.

As the two-dimensional color luminance meter, CA2000 manufactured by Konica Minolta Sensing, Inc. was used.

The chromaticity of the surface of the part fabricated under the appropriate conditions and the chromaticity of the surface of the part fabricated by lowering the resin ejection temperature were detected in situ using a two-dimensional color luminance meter included in the three-dimensional fabrication apparatus. The average X value of each part was determined.

The difference between the detection value and the reference value of the average X value of the part fabricated under the appropriate conditions was 0.002. On the other hand, the difference between the detection value and the reference value of the average X value of the part fabricated at a lower resin ejection temperature was 0.02.

From this result, it could be confirmed that the abnormality of the surface state can be detected in situ according to the evaluation criterion that there is no abnormality when the difference between the detection value of the average X value and the reference value is less than 0.005, and there is abnormality when it is 0.01 or more.

In addition, the average X value of each part similarly obtained using an independent two-dimensional color luminance meter after the completion of the fabrication was also equivalent to the in situ detection result. From this result, it was confirmed that the in-situ detection of the abnormality of the surface state according to the present embodiment is not inferior to the conventional detection after the completion of the fabrication.

### Example 1-3

An example of “Embodiment 1-3: A three-dimensional fabrication method using a material extrusion deposition method (FDM) in which a dielectric constant of a three-dimensional fabricated object in the middle of fabrication is detected in situ by a three-dimensional fabrication apparatus including a reflection frequency analyzer with a tag as a detector” will be described.

According to an example of the evaluation criterion used in the present example, there was no defect in a case where the peak shift ratio PS was less than 5%, and there was a defect in a case where the peak shift ratio PS was 5% or more. Thereby, it was confirmed whether or not a defect of the three-dimensional fabricated object can be detected in the present embodiment. A resonance frequency obtained from a three-dimensional fabricated object having no defect prepared in advance was used as the reference value.

A three-dimensional fabrication apparatus of a material extrusion deposition (FDM) type including a reflection frequency analyzer with a tag as a detector (having a configuration illustrated in FIG. 5) was used to fabricate a three-dimensional fabricated object. At this time, the three-dimensional fabricated object was fabricated under conditions in which abnormalities in the surface state were intentionally likely to occur, by fabricating while the resin ejection temperature was temporarily lowered compared with that in the appropriate conditions.

The main body section of a material extrusion deposition for fabrication of a three-dimensional fabricated object and the fabrication material were the same as those used in Example 1-1.

As the chipless RFID tag, one in which an antenna was patterned with metal ink on a resin base material was used.

As the electromagnetic wave transceiver, a vector network analyzer coupled with a horn antenna was used.

The resonance frequency of the part fabricated under the appropriate condition and the resonance frequency of the part fabricated at lower resin ejection temperature were detected in situ by using a reflection frequency analyzer with a tag included in the three-dimensional fabrication apparatus. A peak shift ratio PS of each part was obtained.

The peak shift ratio PS of the part fabricated under the appropriate conditions was 0.05%. On the other hand, the peak shift ratio PS of the part fabricated at a lower resin ejection temperature was 8%.

From this result, it could be confirmed that the in-situ detection of a defect according to the evaluation criterion in which there is no defect in a case where the peak shift ratio PS is less than 5%, and there is a defect in a case where the peak shift ratio PS is 5% or more.

In addition, the peak shift ratio PS of each part obtained in the same manner using an independent reflection frequency analyzer with a tag after the completion of the fabrication was also equivalent to the detection result in situ. From this result, it was confirmed that the in-situ detection of a defect according to the present embodiment is not inferior to the conventional detection after the completion of the fabrication.

### Example 1-4

An example of “Embodiment 1-4: A three-dimensional fabrication method using a material extrusion deposition method (FDM) in which electromagnetic wave reflection intensity or electromagnetic wave absorption intensity of a three-dimensional fabricated object in the middle of fabrication is detected in situ by a three-dimensional fabrication apparatus including a reflection frequency analyzer without a tag as a detector” will be described.

According to an example of the evaluation criterion used in the present example, there was no defect in a case where the ratio of the difference between the detection value of the integrated reflection intensity and the reference value was less than 10%, and there was a defect in a case where the ratio was 10% or more. Thereby, it was confirmed whether the presence or absence of a defect could be detected in the present embodiment. As the reference value, the integrated reflection intensity obtained from a three-dimensional fabricated object having no defect prepared in advance was used.

A three-dimensional fabrication apparatus (having a configuration illustrated in FIG. 7) of a material extrusion deposition type (FDM) including a reflection frequency analyzer without a tag as a detector was used to fabricate a three-dimensional fabricated object. At this time, the three-dimensional fabricated object was fabricated under conditions in which voids were intentionally likely to occur between layers, by fabricating while the resin ejection temperature was temporarily lowered compared with that in the appropriate conditions.

The main body section of a material extrusion deposition for fabricating a three-dimensional fabricated object was the same as that in Example 1-1.

As the fabrication material, a filament made of carbon nanofiber 40 vol % and nylon 60 vol % was used.

A vector network analyzer coupled with a horn antenna was used as the electromagnetic wave transceiver of the reflection frequency analyzer without a tag.

The reflection intensity of a part fabricated under an appropriate condition and the reflection intensity of a part fabricated at a lower resin ejection temperature were detected in situ using a reflection frequency analyzer without a tag included in the three-dimensional fabrication apparatus. The integrated reflection intensity of each part was determined. The frequency band of the electromagnetic wave to be emitted and the frequency band for obtaining the integrated value were both 6 to 11 GHz.

The ratio of the difference between the detection value of the integrated reflection intensity of the part fabricated under the appropriate conditions and the reference value was 2%. On the other hand, the ratio of the difference between the detection value of the integrated reflection intensity of the part fabricated at a lower resin ejection temperature and the reference value was 12%.

From this result, it could be confirmed that the presence or absence of a defect can be detected in situ in the evaluation criterion in which there is no defect in a case where the ratio of the difference between the detection value of the integrated reflection intensity and the reference value is less than 10%, and there is a defect in a case where the ratio is 10% or more.

In addition, the integrated reflection intensity of each part obtained in the same manner using an independent reflection frequency analyzer without a tag after the completion of the fabrication was also equivalent to the detection result in situ. From this result, it was confirmed that the in-situ detection of the presence or absence of a defect according to the present embodiment is not inferior to the conventional detection after the completion of the fabrication.

### Example 2-2

An example of “Embodiment 2-2: A three-dimensional fabrication method using a powder sintering lamination method (SLS) in which the chromaticity of the surface of a three-dimensional fabricated object in the middle of fabrication is detected in situ by a three-dimensional fabrication apparatus including a two-dimensional color luminance meter as a detector” will be described.

According to an example of the evaluation criterion used in the present example, there is no defect in a case where the difference between the detection value of the average X value and the reference value is less than 0.005, and there is a defect in a case where the difference is 0.01 or more. Thus, it was confirmed whether an abnormality in the surface state of a three-dimensional fabricated object can be detected in the present embodiment. As the reference value, an average X value obtained from a three-dimensional fabricated object prepared in advance and having no abnormality in its surface state was used.

A three-dimensional fabricated object was fabricated using a three-dimensional fabrication apparatus of a powder sintering lamination type (SLS) (having a configuration illustrated in FIG. 11) including a two-dimensional color luminance meter as a detector. At this time, the three-dimensional fabricated object was fabricated under conditions in which abnormalities in the surface state were intentionally likely to occur, by fabricating while the laser power was temporarily decreased compared with that in the appropriate conditions.

sPro140 manufactured by 3DSystems Co., Ltd. was used as a main body section of a powder sintering lamination for fabricating a three-dimensional fabricated object.

As the fabrication material, DuraForm PA (nylon-based resin material) manufactured by 3Dsystems Corporation was used as a thermoplastic resin.

The X-ray source and the X-ray detector of the X-ray Talbot-Lau imaging device were the same as those used in Example 1-1.

The two-dimensional color luminance meter was the same as that used in Example 1-2.

The chromaticity of the surface of the part formed under the appropriate conditions and the chromaticity of the surface of the part formed with a reduced laser power were detected in situ using a two-dimensional color luminance meter included in the three-dimensional fabrication apparatus. The average X value of each part was determined.

The difference between the detection value of the average X value of the part fabricated under the appropriate conditions and the reference value was 0.003. On the other hand, the difference between the detection value of the average X value of the part formed with a reduced laser power and the reference value was 0.04.

From this result, it was confirmed that the abnormality of the surface state could be detected in situ in the evaluation criterion that there is no abnormality when the difference between the detected average X value and the reference value was less than 0.005, and there is no abnormality when the difference was 0.01 or more.

In addition, the average X value of each part similarly obtained using an independent two-dimensional color luminance meter after the completion of the fabrication was also equivalent to the in situ detection result. From this result, it was confirmed that the in-situ detection of the abnormality of the surface state according to the present embodiment is not inferior to the conventional detection after the completion of the fabrication.

### Example 2-3

An example of “Embodiment 2-3: A three-dimensional fabrication method using a powder sintering lamination method (SLS) in which a dielectric constant of a three-dimensional fabricated object in the middle of fabrication is detected in situ by a three-dimensional fabrication apparatus including a reflection frequency analyzer with a tag as a detector” will be described.

According to an example of the evaluation criterion used in the present example, there was no defect in a case where the peak shift ratio PS was less than 5%, and there was a defect in a case where the peak shift ratio PS was 5% or more. Thereby, it was confirmed whether or not a defect of the three-dimensional fabricated object can be detected in the present embodiment. A resonance frequency obtained from a three-dimensional fabricated object having no defect prepared in advance was used as the reference value.

A three-dimensional fabricated object was fabricated using a three-dimensional fabrication apparatus of a powder sintering lamination type (SLS) (having a configuration illustrated in FIG. 12) including a reflection frequency analyzer with a tag as a detector. At this time, the three-dimensional fabricated object was fabricated under conditions in which abnormalities in the surface state were intentionally likely to occur, by fabricating while the laser power was temporarily decreased compared with that in the appropriate conditions.

The main body section of the powder sintering lamination method for fabricating the three-dimensional fabricated object and the fabrication material were the same as those used in Example 2-2.

As the chipless RFID tag and the electromagnetic wave transceiver, the same ones as in Example 1-3 were used.

A resonance frequency in a part fabricated under appropriate conditions and a resonance frequency in fabrication with a reduced laser power were detected in situ using a reflection frequency analyzer with a tag included in the three-dimensional fabrication apparatus. A peak shift ratio PS of each part was obtained.

The peak shift ratio PS of the part fabricated under the appropriate conditions was 0.07%. On the other hand, the peak shift ratio PS of the part fabricated with a reduced laser power was 9%.

From this result, it could be confirmed that the in-situ detection of a defect according to the evaluation criterion in which there is no defect in a case where the peak shift ratio PS is less than 5%, and there is a defect in a case where the peak shift ratio PS is 5% or more.

In addition, the peak shift ratio PS of each part obtained in the same manner using an independent reflection frequency analyzer with a tag after the completion of the fabrication was also equivalent to the detection result in situ. From this result, it was confirmed that the in-situ detection of a defect according to the present embodiment is not inferior to the conventional detection after the completion of the fabrication.

### Example 2-4

An example of “Embodiment 2-4: A three-dimensional fabrication method using a powder sintering lamination method (SLS) in which electromagnetic wave reflection intensity or electromagnetic wave absorption intensity of a three-dimensional fabricated object in the middle of fabrication is detected in situ by a three-dimensional fabrication apparatus including a reflection frequency analyzer without a tag as a detector” will be described.

According to an example of the evaluation criterion used in the present example, there was no defect in a case where the ratio of the difference between the detection value of the integrated reflection intensity and the reference value was less than 10%, and there was a defect in a case where the ratio was 10% or more. Thereby, it was confirmed whether the presence or absence of a defect could be detected in the present embodiment. As the reference value, the integrated reflection intensity obtained from a three-dimensional fabricated object having no defect prepared in advance was used.

A three-dimensional fabricated object was fabricated using a three-dimensional fabrication apparatus of a powder sintering lamination type (SLS) (having a configuration illustrated in FIG. 13) including a reflection frequency analyzer without a tag as a detector. At this time, the three-dimensional fabricated object was fabricated under conditions in which voids were intentionally likely to occur between layers, by fabricating while the laser power was temporarily decreased compared with that in the appropriate conditions.

The main body section of a powder sintering lamination method for fabricating a three-dimensional fabricated object was the same as that in Example 2-2.

As the fabrication material, powder composed of 40 vol % of carbon nanofibers and 60 vol % of nylon was used.

The electromagnetic wave transceiver of the reflection frequency analyzer without a tag was the same as that used in Example 1-4.

The reflection intensity of a part fabricated under an appropriate condition and the reflection intensity of a part fabricated with a reduced laser power were detected in situ by using a reflection frequency analyzer without a tag included in the three-dimensional fabrication apparatus. The integrated reflection intensity of each part was determined. The frequency band of the electromagnetic wave to be emitted and the frequency band for obtaining the integrated value were both 6 to 11 GHz.

The ratio of the difference between the detection value of the integrated reflection intensity of the part fabricated under the appropriate conditions and the reference value was 3%. On the other hand, the ratio of the difference between the reference value and the detection value of the integrated reflection intensity of the part fabricated with a reduced laser power was 15%.

From this result, it could be confirmed that the presence or absence of a defect can be detected in situ in the evaluation criterion in which there is no defect in a case where the ratio of the difference between the detection value of the integrated reflection intensity and the reference value is less than 10%, and there is a defect in a case where the ratio is 10% or more.

In addition, the integrated reflection intensity of each part obtained in the same manner using an independent reflection frequency analyzer without a tag after the completion of the fabrication was also equivalent to the detection result in situ. From this result, it was confirmed that the in-situ detection of the presence or absence of a defect according to the present embodiment is not inferior to the conventional detection after the completion of the fabrication.

### Example 3-1

An example of “Embodiment 3-1: A three-dimensional fabrication method using a material jetting (MJ) in which an X-ray interference image of a three-dimensional fabricated object in the middle of fabrication is detected in situ by a three-dimensional fabrication apparatus including an X-ray Talbot-Lau imaging device as a detector” will be described.

According to an example of the evaluation criterion used in the present example, there is no defect in a case where the ratio of the difference between the detection value of the contrast value and the reference value is less than 10%, and there is a defect in a case where the ratio is 10% or more. Thereby, it was confirmed whether the presence or absence of a defect could be detected in the present embodiment. As the reference value, a contrast value obtained from a three-dimensional fabricated object having no defect prepared in advance was used.

A three-dimensional fabricated object was fabricated using a three-dimensional fabrication apparatus of a material jetting (MJ) type (having the configuration illustrated in FIG. 15) including an X-ray Talbot-Lau imaging device as a detector. At this time, the three-dimensional fabricated object was fabricated under conditions in which voids were intentionally likely to occur between layers, by fabrication while the movement speed of the inkjet head was temporarily increased compared with that in the appropriate conditions.

A three-dimensional fabrication system including an inkjet head (Piezo Head 512 L, manufactured by Konica Minolta, Inc) and an ink tank communicating with the inkjet head was used as a main body section of a material jetting system for fabricating a three-dimensional fabricated object.

An acrylic resin ink was used as the fabrication material.

The X-ray source and the X-ray detector of the X-ray Talbot-Lau imaging device were the same as those used in Example 1-1.

A differential phase image of a part fabricated under appropriate conditions and a differential phase image of a part fabricated at an increased movement speed of the inkjet head were captured and generated in situ using an X-ray Talbot-Lau imaging device included in the three-dimensional fabrication apparatus. The contrast of the differential phase image was digitized and averaged, and the contrast value of each part was obtained.

The ratio of the difference between the detection value of the contrast value of the part fabricated under the proper conditions and the reference value was 2.4%. On the other hand, the ratio of the difference between the detection value of the contrast value of the part fabricated with an increased movement speed of the inkjet head and the reference value was 13%.

From this result, it was confirmed that the presence or absence of a defect can be detected in situ according to the evaluation criterion that there is no defect when the ratio of the difference between the detection value of the contrast value and the reference value is less than 10%, and there is a defect when the ratio is 10% or more.

In addition, the contrast value of each part obtained in the same manner using an independent X-ray Talbot-Lau imaging device after the completion of the fabrication was equivalent to the detection result in situ. From this result, it was confirmed that the in-situ detection of the presence or absence of a defect according to the present embodiment is not inferior to the conventional detection after the completion of the fabrication.

### Example 3-2

An example of “Embodiment 3-2: A three-dimensional fabrication method using a material jetting (MJ) in which the chromaticity of the surface of a three-dimensional fabricated object in the middle of fabrication is detected in situ by a three-dimensional fabrication apparatus including a two-dimensional color luminance meter as a detector” will be described.

According to an example of the evaluation criterion used in the present example, there is no defect in a case where the difference between the detection value of the average X value and the reference value is less than 0.005, and there is a defect in a case where the difference is 0.01 or more. Thus, it was confirmed whether an abnormality in the surface state of a three-dimensional fabricated object can be detected in the present embodiment. As the reference value, an average X value obtained from a three-dimensional fabricated object prepared in advance and having no abnormality in its surface state was used.

A three-dimensional fabricated object was fabricated using a three-dimensional fabrication apparatus of a material jetting (MJ) type (having the configuration illustrated in FIG. 17) including a two-dimensional color luminance meter as a detector. At this time, the three-dimensional fabricated object was fabricated under conditions in which abnormalities in the surface state were intentionally likely to occur, by fabricating while the movement speed of the inkjet head was temporarily increased compared with that in the appropriate conditions.

The main body section of the material jetting method for fabricating the three-dimensional fabricated object and the fabrication material were the same as those used in Example 3-1.

The two-dimensional color luminance meter was the same as that used in Example 1-2.

The chromaticity of the surface of the part fabricated under the appropriate conditions and the chromaticity of the surface of the part fabricated at an increased the movement speed of the inkjet head were detected in situ using a two-dimensional color luminance meter included in the three-dimensional fabrication apparatus. The average X value of each part was determined.

The difference between the detection value of the average X value of the part fabricated under the appropriate conditions and the reference value was 0.0013. On the other hand, the difference between the detection value of the average X value of the part fabricated with the increased movement speed of the inkjet head and the reference value was 0.015.

From this result, it could be confirmed that the abnormality of the surface state can be detected in situ according to the evaluation criterion that there is no abnormality when the difference between the detection value of the average X value and the reference value is less than 0.005, and there is abnormality when it is 0.01 or more.

In addition, the average X value of each part similarly obtained using an independent two-dimensional color luminance meter after the completion of the fabrication was also equivalent to the in situ detection result. From this result, it was confirmed that the in-situ detection of the abnormality of the surface state according to the present embodiment is not inferior to the conventional detection after the completion of the fabrication.

### Example 3-3

An example of “Embodiment 3-3: A three-dimensional fabrication method using a material jetting (MJ) in which a dielectric constant of a three-dimensional fabricated object in the middle of fabrication is detected in situ by a three-dimensional fabrication apparatus including a reflection frequency analyzer with a tag as a detector” will be described.

According to an example of the evaluation criterion used in the present example, there was no defect in a case where the peak shift ratio PS was less than 5%, and there was a defect in a case where the peak shift ratio PS was 5% or more. Thereby, it was confirmed whether or not a defect of the three-dimensional fabricated object can be detected in the present embodiment. A resonance frequency obtained from a three-dimensional fabricated object having no defect prepared in advance was used as the reference value.

A three-dimensional fabricated object was fabricated using a three-dimensional fabrication apparatus of a material jetting (MJ) type (having a configuration illustrated in FIG. 19) including a reflection frequency analyzer with a tag as a detector. At this time, the three-dimensional fabricated object was fabricated under conditions in which abnormalities in the surface state were intentionally likely to occur, by fabricating while the movement speed of the inkjet head was temporarily increased compared with that in the appropriate conditions.

The main body section of the material jetting method for fabricating the three-dimensional fabricated object and the fabrication material were the same as those used in Example 3-1.

As the chipless RFID tag and the electromagnetic wave transceiver, the same ones as in Example 1-3 were used.

A resonance frequency of a part fabricated under appropriate conditions and a resonance frequency in fabrication with the increased movement speed of the inkjet head were detected in situ using a reflection frequency analyzer with a tag included in the three-dimensional fabrication apparatus. A peak shift ratio PS of each part was obtained.

The peak shift ratio PS of the part fabricated under the appropriate conditions was 0.05%. On the other hand, the peak shift ratio PS of the part fabricated with the increased movement speed of the inkjet head was 7%.

From this result, it could be confirmed that the in-situ detection of a defect according to the evaluation criterion in which there is no defect in a case where the peak shift ratio PS is less than 5%, and there is a defect in a case where the peak shift ratio PS is 5% or more.

In addition, the peak shift ratio PS of each part obtained in the same manner using an independent reflection frequency analyzer with a tag after the completion of the fabrication was also equivalent to the detection result in situ. From this result, it was confirmed that the in-situ detection of a defect according to the present embodiment is not inferior to the conventional detection after the completion of the fabrication.

### Example 4-1

An example of “Embodiment 4-1: A three-dimensional fabrication method using a stereolithography (SLA) in which an X-ray interference image of a three-dimensional fabricated object in the middle of fabrication is detected in situ by a three-dimensional fabrication apparatus including an X-ray Talbot-Lau imaging device as a detector” will be described.

According to an example of the evaluation criterion used in the present example, there is no defect in a case where the ratio of the difference between the detection value of the contrast value and the reference value is less than 10%, and there is a defect in a case where the ratio is 10% or more. Thereby, it was confirmed whether the presence or absence of a defect could be detected in the present embodiment. As the reference value, a contrast value obtained from a three-dimensional fabricated object having no defect prepared in advance was used.

A three-dimensional fabricated object was fabricated using a three-dimensional fabrication apparatus of a stereolithography type (SLA) including an X-ray Talbot-Lau imaging device as a detector (having the configuration illustrated in FIG. 22). At this time, the three-dimensional fabricated object was fabricated under conditions in which voids were intentionally likely to occur between layers, by fabricating while the irradiation energy was temporarily decreased compared with that in the appropriate conditions.

Novel 1.0 manufactured by XYZ Printing Co., Ltd. was used as a main body section of a stereolithography method for fabricating a three-dimensional fabricated object.

As the fabrication material, a photocurable acrylic resin composition was used.

The X-ray source and the X-ray detector of the X-ray Talbot-Lau imaging device were the same as those used in Example 1-1.

A differential phase image of a part fabricated under appropriate conditions and a differential phase image of a part fabricated with a deceased irradiation energy were captured and generated in situ using an X-ray Talbot-Lau imaging device included in the three-dimensional fabrication apparatus. The contrast of the differential phase image was digitized and averaged, and the contrast value of each part was obtained.

The ratio of the difference between the detection value of the contrast value of the part fabricated under the proper conditions and the reference value was 1.5%. On the other hand, the ratio of the difference between the detection value of the contrast value of the part fabricated with a deceased irradiation energy and the reference value was 11%.

From this result, it was confirmed that the presence or absence of a defect can be detected in situ according to the evaluation criterion that there is no defect when the ratio of the difference between the detection value of the contrast value and the reference value is less than 10%, and there is a defect when the ratio is 10% or more.

In addition, the contrast value of each part obtained in the same manner using an independent X-ray Talbot-Lau imaging device after the completion of the fabrication was equivalent to the detection result in situ. From this result, it was confirmed that the in-situ detection of the presence or absence of a defect according to the present embodiment is not inferior to the conventional detection after the completion of the fabrication.

### Example 4-2

An example of “Embodiment 4-2: A three-dimensional fabrication method using a stereolithography (SLA) in which chromaticity of the surface of a three-dimensional fabricated object in the middle of fabrication is detected in situ by a three-dimensional fabrication apparatus including a two-dimensional color luminance meter as a detector” will be described.

According to an example of the evaluation criterion used in the present example, there is no defect in a case where the difference between the detection value of the average X value and the reference value is less than 0.005, and there is a defect in a case where the difference is 0.01 or more. Thus, it was confirmed whether an abnormality in the surface state of a three-dimensional fabricated object can be detected in the present embodiment. As the reference value, an average X value obtained from a three-dimensional fabricated object prepared in advance and having no abnormality in its surface state was used.

A three-dimensional fabricated object was fabricated using a three-dimensional fabrication apparatus (having the configuration illustrated in FIG. 23) of a stereolithography type (SLA) including a two-dimensional color luminance meter as a detector was used to fabricate a three-dimensional fabricated object. At this time, the three-dimensional fabricated object was fabricated under conditions in which abnormalities in the surface state were intentionally likely to occur, by fabricating while the irradiation energy was temporarily decreased compared with that in the appropriate conditions.

The main body section and the fabrication material of the stereolithography for fabricating the three-dimensional fabricated object were the same as those in Example 4-1.

The two-dimensional color luminance meter was the same as that used in Example 1-2.

The chromaticity of the surface of the part fabricated under the appropriate conditions and the chromaticity of the surface of the part fabricated with a decreased irradiation energy were detected in situ using a two-dimensional color luminance meter included in the three-dimensional fabrication apparatus. The average X value of each part was determined.

The difference between the detection value of the average X value of the part fabricated under the appropriate conditions and the reference value was 0.0012. On the other hand, the difference between the detection value of the average X value of the part fabricated with a deceased irradiation energy and the reference value was 0.016.

From this result, it could be confirmed that the abnormality of the surface state can be detected in situ according to the evaluation criterion that there is no abnormality when the difference between the detection value of the average X value and the reference value is less than 0.005, and there is abnormality when it is 0.01 or more.

In addition, the average X value of each part similarly obtained using an independent two-dimensional color luminance meter after the completion of the fabrication was also equivalent to the in situ detection result. From this result, it was confirmed that the in-situ detection of the abnormality of the surface state according to the present embodiment is not inferior to the conventional detection after the completion of the fabrication.

### Example 4-3

An example of “Embodiment 4-3: A three-dimensional fabrication method using a stereolithography (SLA) in which a dielectric constant of a three-dimensional fabricated object in the middle of fabrication is detected in situ by a three-dimensional fabrication apparatus including a reflection frequency analyzer with a tag as a detector” will be described.

According to an example of the evaluation criterion used in the present example, there was no defect in a case where the peak shift ratio PS was less than 5%, and there was a defect in a case where the peak shift ratio PS was 5% or more. Thereby, it was confirmed whether or not a defect of the three-dimensional fabricated object can be detected in the present embodiment. A resonance frequency obtained from a three-dimensional fabricated object having no defect prepared in advance was used as the reference value.

A three-dimensional fabricated object was fabricated using a three-dimensional fabrication apparatus of a stereolithography (SLA) type (having the configuration illustrated in FIG. 24) including a reflection frequency analyzer with a tag as a detector. At this time, the three-dimensional fabricated object was fabricated under conditions in which abnormalities in the surface state were intentionally likely to occur, by fabricating while the irradiation energy was temporarily decreased compared with that in the appropriate conditions.

The main body section and the fabrication material of the stereolithography for fabricating the three-dimensional fabricated object were the same as those in Example 4-1.

As the chipless RFID tag and the electromagnetic wave transceiver, the same ones as in Example 1-3 were used.

A resonance frequency in apart fabricated under an appropriate condition and a resonance frequency in a part fabricated with a deceased irradiation energy were detected in situ by using a reflection frequency analyzer with a tag included in the three-dimensional fabrication apparatus. A peak shift ratio PS of each part was obtained.

The peak shift ratio PS of the part fabricated under the appropriate conditions was 0.04%. On the other hand, the peak shift ratio PS of the part fabricated with the decreased irradiation energy was 8%.

From this result, it could be confirmed that the in-situ detection of a defect according to the evaluation criterion in which there is no defect in a case where the peak shift ratio PS is less than 5%, and there is a defect in a case where the peak shift ratio PS is 5% or more.

In addition, the peak shift ratio PS of each part obtained in the same manner using an independent reflection frequency analyzer with a tag after the completion of the fabrication was also equivalent to the detection result in situ. From this result, it was confirmed that the in-situ detection of a defect according to the present embodiment is not inferior to the conventional detection after the completion of the fabrication.

Although the disclosure has been described with respect to only a limited number of embodiments, those skilled in the art, having benefit of this disclosure, will appreciate that various other embodiments may be devised without departing from the scope of the present disclosure.

Accordingly, the scope of the invention should be limited only by the attached claims.

### Industrial Applicability

The present invention is applicable to a method for manufacturing a three-dimensional fabricated object and a device for manufacturing a three-dimensional fabricated object capable of improving manufacturing efficiency or manufacturing a high-quality three-dimensional fabricated object.

### REFERENCE SIGNS LIST

10 three-dimensional fabrication apparatus of a material jetting type
11 stage
12 inkjet
13 inkjet head for model material
13a pipe
13b pump
13c ink tank
14 inkjet head for support material
14a pipe
14b pump
14c ink tank
15 layer thickness adjusting roller
16 light irradiator
20 X-ray source
25 X-ray detector
30 standard light source
35 two-dimensional color luminance meter
40 chipless rfid tag
45 electromagnetic wave transceiver
50 three-dimensional fabricated object in the middle of manufacturing
60 detected defect
70 laser irradiator for additional process
71 infrared laser light source for additional process
72 galvano mirror for additional process
80 infrared lamp for additional process
100 three-dimensional fabrication apparatus of a powder sintering lamination type
110 fabrication stage
120 thin layer former
121 powder supplier
122 recoater
130 laser irradiator
131 laser light source
132 galvanometer mirror
140 stage support
145 base
210 fabrication table
220 ejection module
600 three-dimensional fabrication apparatus of a stereolithography type
610 fabrication tank
615 window
620 fabrication stage
630 photocurable composition
660 light irradiator

1. A manufacturing method of a three-dimensional fabricated object using an additive manufacturing technology, the method comprising:
detecting, in situ, data on a physical or chemical characteristic of a three-dimensional object under fabrication.

2. The manufacturing method of the three-dimensional fabricated object according to claim 1, wherein the detecting includes detecting the data from an upper surface of the three-dimensional object under fabrication.

3. The manufacturing method of the three-dimensional fabricated object according to claim 1, wherein the detecting includes detecting the data from a side surface of the three-dimensional object under fabrication.

4. The manufacturing method of the three-dimensional fabricated object according to claim 1, wherein the detecting includes detecting the data between layers of the three-dimensional object under fabrication.

5. The manufacturing method of the three-dimensional fabricated object according to claim 1, wherein the detecting includes detecting, as the data, an X-ray interference image of the three-dimensional object under fabrication.

6. The manufacturing method of the three-dimensional fabricated object according to claim 1, wherein the detecting includes detecting, as the data, a chromaticity of a surface of the three-dimensional object under fabrication.

7. The manufacturing method of the three-dimensional fabricated object according to claim 1, wherein the detecting includes detecting, as the data, a dielectric constant of the three-dimensional object under fabrication.

8. The manufacturing method of the three-dimensional fabricated object according to claim 1, wherein the detecting includes detecting, as the data, an electromagnetic wave reflection intensity or an electromagnetic wave absorption intensity of the three-dimensional object under fabrication.

9. The manufacturing method of the three-dimensional fabricated object according to claim 1, wherein the detecting includes detecting, as the data, a progress of a chemical reaction of a material of the three-dimensional object under fabrication.

10. The manufacturing method of the three-dimensional fabricated object according to claim 1, further comprising:
executing, in situ, an additional process or a change in a fabrication condition depending on the data detected in the detecting.

11. A manufacturing device of a three-dimensional fabricated object using an additive manufacturing technology, the manufacturing device comprising:
a detector that detects, in situ, data on a physical or chemical characteristic of a three-dimensional object under fabrication.
